(19) United States
(12) Patent Application Publication
(10) Pub. No.: US 2014/0287167 A1
(43) Pub. Date: Sep. 25, 2014

(54) POLYMERIZABLE COMPOSITION, POLYMER, IMAGE-DISPLAY DEVICE, AND MANUFACTURING METHOD THEREFOR

(71) Applicant: Showa Denko K.K., Minato-ku, Tokyo (JP)

(72) Inventor: Kazuhiko Ooga, Minato-ku (JP)

(73) Assignee: Showa Denko K.K., Minato-ku, Tokyo (JP)

(21) Appl. No.: 14/357,929

(22) PCT Filed: Dec. 26, 2012
(86) PCT No.: PCT/JP2012/083727

§ 371 Date: May 13, 2014

(30) Foreign Application Priority Data
Dec. 27, 2011 (JP) 2011-286438

(51) Int. Cl. C08F 22/10; C08L 33/14; C08L 95/00; C08L 93/04; G02F 1/1335; C08L 33/08

(52) U.S. Cl. CPC C08F 22/10; G02F 1/1335; C08L 33/08; C08L 95/00; C08L 93/04; C08L 33/14
USPC 428/1.33; 526/193; 525/220; 524/705; 524/764; 525/217; 445/24

(57) ABSTRACT

Provided is a polymerizable composition for providing a thin image-display device that does not exhibit display problems due to deformation of an image-display unit, allows high-brightness, high-contrast image display, and tolerates heat well. A polymerizable composition for forming a polymer layer interposed between an image-display unit in an image-display device and a light-transmitting protective part. Said polymerizable composition is characterized by containing the following: (1) a (meth)acryloyl group-containing compound that has a structural unit derived from a (poly)ester polyol and/or a structural unit derived from a (poly)carbonate polyol; (2) a (meth)acryloyl group-containing compound that has a C₉₊ hydrocarbon group; and (3) a photopolymerization initiator.

### TECHNICAL FIELD

The present invention relates to a polymerizable composition used for an image-display device such as a liquid crystal display device used for a smartphone, a tablet PC, or the like, a polymer obtained by polymerizing the composition, a manufacturing method of an image-display device employing the composition, and an image-display device manufactured by the manufacturing method.

### BACKGROUND ART

Conventionally, for example, a liquid crystal display device 101 illustrated in FIG. 4 is known as such a type of image-display device.

As illustrated in FIG. 4, the liquid crystal display device 101 comprises, on a liquid crystal display panel 102, for example, a transparent protection unit 103 composed of glass or plastics.

In such cases, in order to protect the surface of the liquid crystal display panel 102 and a polarizing plate (not illustrated), a space 105 is provided between the liquid crystal display panel 102 and the protection unit 103 by interposing a spacer 104 between the liquid crystal display panel 102 and the protection unit 103.

However, since there is a space 105 between the liquid crystal display panel 102 and the protection unit 103, scattering of light occurs, which causes a decrease in the contrast or the brightness. The space 105 is also an obstacle to obtaining a thin panel.

Although filling a gap between a liquid crystal display panel and a protection unit with a resin is also proposed in view of such a problem (see, for example, Patent Document 1), stress during curing shrinkage of the cured resin creates a deformation on an optical glass holding liquid crystal of the liquid crystal display panel, which causes a display failure such as an alignment disorder of a liquid crystal material.

In order to solve the above-mentioned problems, for example, Patent Document 2 or Patent Document 3 discloses a curable composition with a low elastic modulus and a low volume shrinkage rate when cured using a polyurethane acrylate or an esterified product of a maleic anhydride adduct of a polyisoprene polymer and 2-hydroxyethyl methacrylate.

However, the volume shrinkage rate of the curable composition using a polyurethane acrylate when cured is high (higher than 4.0%), and although the volume shrinkage rate of the curable composition using an esterified product of a maleic anhydride adduct of a polyisoprene polymer and 2-hydroxyethyl methacrylate when cured is low, the resistance to thermal coloration of the cured product becomes large, which has been problematic.

### PRIOR ART DOCUMENTS

### Patent Documents

[Patent Document 1] Japanese Laid-open Patent Publication No. 2005-55641
[Patent Document 2] Japanese Laid-open Patent Publication No. 2008-282000
[Patent Document 3] Japanese Laid-open Patent Publication No. 2009-186958

### SUMMARY OF INVENTION

### Technical Problem

The present invention has been made in view of the above-mentioned problems of conventional art, and aims at providing a polymerizable composition for providing a thin image-display device which does not cause a display failure caused by a deformation of an image-display unit, which makes it possible to display an image with high brightness and high contrast, and which has favorable thermal resistance.

The invention also aims at providing a manufacturing method of an image-display device employing the polymerizable composition.

Further, the invention aims at providing an image-display device manufactured by the manufacturing method of an image-display device employing the polymerizable composition.

### Solution to Problem

In order to solve the above-mentioned problems, the present inventors conducted continuous research to find a photopolymerizable composition containing a (meth)acryloyl group-containing compound having a specific structure that has a small volume shrinkage rate when cured, and that a polymer obtained by polymerizing the composition has low resistance to thermal coloration, thereby completing the invention.

In other words, the invention (I) relates to a polymerizable composition for forming a polymer layer interposed between an image-display unit and a translucent protection unit of an image-display device, the polymerizable composition being characterized by comprising:

(1) a (meth)acryloyl group-containing compound having a structural unit derived from a (poly)ester polyol and/or a structural unit derived from a (poly) carbonate polyol,

(2) a (meth)acryloyl group-containing compound having a hydrocarbon group having nine or more carbon atoms, and

(3) a photopolymerization initiator.

The invention (II) relates to a polymer obtained by polymerizing the polymerizable composition of the invention (I).

The invention (III) relates to a manufacturing method of an image-display device comprising a base unit including an image-display unit, a translucent protection unit, and a polymer layer interposed between the base unit and the protection unit, the method being characterized by comprising:

a process in which the polymerizable composition of the invention (I) is interposed between the base unit and the protection unit, and

a process in which the polymerizable composition is irradiated with light to which a photopolymerization initiator is photosensitive so as to form a polymer layer.

The invention (IV) relates to an image-display device manufactured by the manufacturing method of an image-display device of the invention (III).

More specifically, the invention relates to the following matters [1] to [13].

[1] A polymerizable composition for forming a polymer layer interposed between an image-display unit and a translucent protection unit of an image-display device, the polymerizable composition being characterized by comprising:

(1) a (meth)acryloyl group-containing compound having a structural unit derived from a (poly)ester polyol and/or a structural unit derived from a (poly) carbonate polyol;

(2) a (meth)acryloyl group-containing compound having a hydrocarbon group having nine or more carbon atoms; and

(3) a photopolymerization initiator.

[2] The polymerizable composition according to [1], further comprising:

(4) at least one selected from the group consisting of hydrogenated petroleum resins, hydrogenated terpene resins, hydrogenated rosin esters, hydrogenated polybutadiene and hydrogenated polyisoprene.

[3] The polymerizable composition according to [1] or [2], further comprising:

(5) a (meth)acryloyl group-containing compound having an alcoholic hydroxyl group.

[4] The polymerizable composition according to any one of [1] to [3], further comprising:

(6) at least one selected from the group consisting of a hydrogenated polybutadiene polyol and a hydrogenated polyisoprene polyol.

[5] The polymerizable composition according to any one of [1] to [4], wherein the (meth)acryloyl group-containing compound (1) is a (meth)acryloyl group-containing compound having a structural unit derived from a (poly)ester polyol having a structural unit derived from a hydrogenated dimerdiol and/or a structural unit derived from a (poly)carbonate polyol having a structural unit derived from a hydrogenated dimerdiol.

[6] The polymerizable composition according to any one of [1] to [4], wherein the (meth)acryloyl group-containing compound (1) is a (meth)acryloyl group-containing compound prepared by a reaction of a (poly)ester polyol having a structural unit derived from a hydrogenated dimerdiol and/or a (poly)carbonate polyol having a structural unit derived from a hydrogenated dimerdiol with a (meth)acrylic acid or an alkyl (meth)acrylate.

[7] The polymerizable composition according to any one of [1] to [4], wherein the (meth)acryloyl group-containing compound (1) is a (poly)ester (meth)acrylate prepared by a reaction of a (poly)ester polyol having a structural unit derived from a hydrogenated dimerdiol with a (meth)acrylic acid or an alkyl (meth)acrylate.

[8] The polymerizable composition according to any one of [1] to [4], wherein the (meth)acryloyl group-containing compound (1) is a urethane (meth)acrylate synthesized by using a (poly)ester polyol having a structural unit derived from a hydrogenated dimerdiol and/or a (poly)carbonate polyol having a structural unit derived from a hydrogenated dimerdiol as a raw material component.

[9] A polymer obtained by polymerizing the polymerizable composition according to any one of [1] to [8].

[10] The polymer according to [9], having a refractive index at 25° C. of from 1.48 to 1.52.

[11] A method for manufacturing an image-display device comprising a base unit including an image-display unit, a translucent protection unit, and a polymer layer interposed between the base unit and the protection unit, comprising the steps of

interposing the polymerizable composition according to any one of [1] to [8] between the base unit and the protection unit; and

irradiating the polymerizable composition with light to which a photopolymerization initiator is photosensitive so as to form a polymer layer.

[12] An image-display device manufactured by the method for manufacturing an image-display device according to [11].

[13] The image-display device according to [12], wherein the image-display unit is a liquid crystal display panel.

### Advantageous Effects of Invention

According to a polymerizable composition of the invention, stress due to a volume shrinkage when the polymerizable composition is applied between an image-display unit and a protection unit can be minimized, and therefore an influence of the stress against the image-display unit and the protection unit can also be minimized. As a result, according to the image-display device of the invention, deformation on an image-display unit and a protection unit is minimized.

The refractive index of the polymer of the invention is conventionally closer to the refractive index of a panel constituting an image-display unit or a panel constituting a protection unit than that of a space provided between a liquid crystal display panel and the protection unit, thereby suppressing light reflection at the interface between the protection unit and the polymer or at the interface between the polymer and the image-display unit. As a result, according to the image-display device of the invention, a display with a high brightness and a high contrast without a display failure becomes possible.

In particular, when the image-display unit is a liquid crystal display panel, a display failure such as an alignment disorder of a liquid crystal material can be surely prevented and a high quality display can be realized.

Further, according to the image-display device of the invention, a polymer is interposed between the image-display unit and the protection unit, thereby improving impact resistance.

Still further, since the polymer of the invention has favorable resistance to thermal coloration, a display with high brightness and high contrast can be maintained for a long time.

In addition, according to the invention, an image-display device which is thinner than a conventional example in which a space is provided between an image-display unit and a protection unit can be provided.

### BRIEF DESCRIPTION OF DRAWINGS

FIG. 1 is a cross section illustrating a main unit of an embodiment of a display device pertaining to the invention.

FIG. 2 is a cross section illustrating a main unit of an embodiment of a display device pertaining to the invention.

FIG. 3 is a cross section illustrating a main unit of an embodiment of a display device pertaining to the invention.

FIG. 4 is a cross section illustrating a main unit of a display device pertaining to a conventional art.

### DESCRIPTION OF EMBODIMENTS

The invention will now be described concretely.

The term “(meth)acryloyl group” herein refers to an acryloyl group and/or a methacryloyl group.

Further, the term “(poly)ester polyol” herein refers to a compound having, in one molecule, one or more —COO— bonds and two or more alcoholic hydroxyl groups.

It is noted herein that, when a (poly)ester polyol which may be a raw material for the component (1) which is an essential raw material component for the polymerizable composition of the invention (I) is manufactured, in cases where a polyol which is a raw material for the (poly)ester polyol (in other words, a polyol without a —COO— bond) remains, this polyol is also included in the (poly)ester polyol. In addition, herein, when the component (1) which is an essential component of the polymerizable composition of the invention (I) is manufactured by newly adding polyol other than a raw material polyol included in the (poly)ester polyol, the added polyol is included in the (poly)ester polyol even when the polyol is a polyol without a —COO— bond.

Further, the term “(poly)carbonate polyol” herein refers to a compound having, in one molecule, one or more carbonate bonds and two or more alcoholic hydroxyl groups.

It also is noted herein that, when a (poly)carbonate polyol which may be a raw material for the component (1) which is an essential raw material component for the polymerizable composition of the invention (I) is manufactured, in cases where a polyol which is a raw material for the (poly)carbonate polyol (in other words, a polyol without a carbonate bond) remains, this polyol is also included in the (poly)carbonate polyol. In addition, herein, when the component (1) which is an essential component of the polymerizable composition of the invention (I) is manufactured by newly adding polyol other than a raw material polyol included in the (poly) carbonate polyol, the added polyol is included in the (poly)carbonate polyol, even when the polyol is a polyol without a carbonate bond.

First, the invention (I) will be described.

The invention (I) is a polymerizable composition for forming a polymer layer interposed between an image-display unit and a translucent protection unit of an image-display device, wherein the polymerizable composition comprises, as essential components, the following Component (1), the following Component (2), and the following Component (3).

Component (1): a (meth)acryloyl group-containing compound having a structural unit derived from a (poly)ester polyol and/or a structural unit derived from a (poly)carbonate polyol

Component (2): a (meth)acryloyl group-containing compound having a hydrocarbon group having nine or more carbon atoms

Component (3): a photopolymerization initiator

The term “a structural unit derived from a (poly)ester polyol” herein refers to the structure of a compound which has, in one molecule, one or more —COO— bonds and two or more alcoholic hydroxyl groups and in which compound H is removed from at least one of the alcoholic hydroxyl groups, and examples thereof include the structure of —O—Ra—OCO (-RcCOO—RaOCO)ₙ—RcCOO—Ra—O— (here, n is an integer of 0 or more) derived from a reaction product of a dicarboxylic acid represented by HOOC-Rc-COOH and a diol represented by HO—Ra—OH.

Further, the term “a structural unit derived from a (poly) carbonate polyol” herein refers to the structure of a compound which has, in one molecule, one or more carbonate bonds and two or more alcoholic hydroxyl groups and in which compound H is removed from at least one of the alcoholic hydroxyl groups, and examples thereof include the structure of —O—R—(OCOOR)ₙ—O— (here, n is an integer of 0 or more) derived from a reaction product of a diol represented by HO—R—OH and a carbonate compound, or the structure of Z—[(OCOOR)ₙ—O]ₘ— (here, n is an integer of 0 or more, and m is 3 or 4) derived from a reaction product of an m-valent alcohol represented by Z(OH)ₘ, a diol represented by HO—R—OH, and a carbonate compound.

First, the component (1) which is an essential raw material component for the polymerizable composition of the invention (I) will be described.

The component (1) which is an essential raw material component of polymerizable composition of the invention (I) is a (meth)acryloyl group-containing compound having a structural unit derived from a (poly)ester polyol and/or a structural unit derived from a (poly)carbonate polyol.

The component (1) which is an essential raw material component of polymerizable composition of the invention (I) is not particularly limited, as long as it is a compound having, in one molecule, a structural unit derived from a (poly)ester polyol and/or a structural unit derived from a (poly)carbonate polyol, and a (meth)acryloyl group.

A (poly)ester polyol which may be a raw material of the component (1) which is an essential raw material component of the polymerizable composition of the invention (I) is not particularly limited, as long as it is a compound having, in one molecule, one or more —COO— bonds and two or more alcoholic hydroxyl groups.

Examples of the (poly)ester polyol which may be a raw material of the component (1) which is an essential raw material component of the polymerizable composition of the invention (I) include a (poly)ester polyol having a structural unit derived from a polycarboxylic acid having a chain-shaped hydrocarbon chain and a structural unit derived from a polyol having a chain-shaped hydrocarbon chain, a (poly)ester polyol having a structural unit derived from a polycarboxylic acid having an alicyclic structure-containing hydrocarbon chain and a structural unit derived from a polyol having a chain-shaped hydrocarbon chain, a (poly)ester polyol having a structural unit derived from a polycarboxylic acid having a chain-shaped hydrocarbon chain and a structural unit derived from a polyol having an alicyclic structure-containing hydrocarbon chain, a (poly)ester polyol having a structural unit derived from a polycarboxylic acid having an alicyclic structure-containing hydrocarbon chain and a structural unit derived from a polyol having an alicyclic structure-containing hydrocarbon chain, a (poly)ester polyol having a structural unit derived from a polycarboxylic acid having an aromatic ring structure-containing hydrocarbon chain and a structural unit derived from a polyol having a chain-shaped hydrocarbon chain, a (poly)ester polyol having a structural unit derived from a polycarboxylic acid having an aromatic ring structure-containing hydrocarbon chain and a structural unit derived from a polyol having an alicyclic structure-containing hydrocarbon chain, a (poly)ester polyol having a structural unit derived from a polycarboxylic acid having a chain-shaped hydrocarbon chain and a structural unit derived from a polyol having an aromatic ring structure-containing hydrocarbon chain, and a (poly)ester polyol having a structural unit derived from a polycarboxylic acid having an alicyclic structure-containing hydrocarbon chain and a structural unit derived from a polyol having an aromatic ring structure-containing hydrocarbon chain.

Among these polyols, preferred are polyols whose number of carbon atoms is eight or more.

Examples of the polyols whose number of carbon atoms is eight or more include 1,4-cyclohexanedimethanol, 1,2-cyclohexanedimethanol, 1,3-cyclohexanedimethanol, 2-methyl-1,1-cyclohexanedimethanol, tricyclo[5.2.1.0^{2,6}]decanedimethanol, 1,9-nonanediol, 2-methyl-1,8-octane diol, 1,10-decadiol, 1,12-dodecanediol, dimerdiol, and hydrogenated dimerdiol.

Among these polyols whose number of carbon atoms is eight or more, particularly preferred is hydrogenated dimerdiol.

Among the polycarboxylic acid, preferred is a polycarboxylic acid whose number of carbon atoms except for the carbon in the carboxylic acid structure (—COOH) is seven or more.

Examples of such a polycarboxylic acid include 1,9-nonanedioic acid, sebacic acid, 1,12-dodecanedioic acid, dimer acid, and hydrogenated dimer acid.

Among the polycarboxylic acids whose number of carbon atoms except for the carbon in the carboxylic acid structure (—COOH) is seven or more, particularly preferred are sebacic acid, 1,12-dodecanedioic acid, and hydrogenated dimer acid.

A preferred combination of a raw material polyol constituting a (poly)ester polyol and a polycarboxylic acid is a combination of a polyol whose number of carbon atoms is eight or more and a polycarboxylic acid whose number of carbon atoms except for the carbon in the carboxylic acid structure (—COOH) is seven or more, and particularly preferably, a combination of hydrogenated dimerdiol and at least one selected from sebacic acid, 1,12-dodecanedioic acid, and hydrogenated dimer acid.

In general, the term “dimer acid” refers to a dimer acid obtained by the reaction of a fatty acid whose number of carbon atoms is 14 to 22 having 2 to 4 ethylenic double bonds (hereinafter referred to as an unsaturated fatty acid A), preferably a fatty acid whose number of carbon atoms 14 to 22 having two ethylenic double bonds, and a fatty acid whose number of carbon atoms is 14 to 22 having 1 to 4 ethylenic double bonds (hereinafter referred to as an unsaturated fatty acid B), preferably a fatty acid whose number of carbon atoms is 14 to 22 having 1 or 2 ethylenic double bonds at a double bond portion. In the above, examples of the unsaturated fatty acid A include tetradecadienoic acid, hexadecadienoic acid, octadecadienoic acid (linoleic acid, or the like), eicosadienoic acid, docosadienoic acid, octadecatrienoic acid (linolenic acid, or the like), and eicosatetraenoic acid (arachidonic acid, or the like). Most preferred is linoleic acid. Examples of the unsaturated fatty acid B include, other than those illustrated above, as a fatty acid whose number of carbon atoms is 14 to 22 having one ethylenic double bond, tetradecenoic acid (tsuzuic acid, sperm acid, myristoleic acid), hexadecenoic acid (palmitoleic acid, or the like), octadecenoic acid (oleic acid, elaidic acid, vaccenic acid, or the like), eicosenoic acid (gadoleic acid, or the like), docosenoic acid (erucic acid, cetoleic acid, brassidic acid, or the like). Most preferred is oleic acid or linoleic acid.

In the above-mentioned dimerization reaction, the use rates of the unsaturated fatty acid A and the unsaturated fatty acid B (mole fraction) are preferably about from 1:1.2 to 1.2:1, and most preferably 1:1. The above-mentioned dimerization reaction can be conducted according to a known method, for example, the method described in Japanese Laid-open Patent Publication No. H9-136861. In other words, the reaction can be realized, for example, by adding a Lewis acid or Broensted acid type liquid or solid catalyst, preferably a montmorillonite active white clay to the unsaturated fatty acid A and the unsaturated fatty acid B in an amount of from 1 to 20% by weight, preferably from 2 to 8% by weight with respect to A+B and heating the mixture at from 200 to 270° C., preferably from 220 to 250° C. The pressure during the reaction is usually in a state in which a small pressure is applied, and may be a normal pressure. The reaction time varies depending on the amount of catalyst and the reaction temperature, and is usually from 5 to 7 hours. After the reaction, the catalyst is filtered out, and then unreacted raw materials or isomerized fatty acids are evaporated by conducting distillation under reduced pressure, and thereafter, a dimer acid fraction is obtained by distillation. The above-mentioned dimerization reaction is thought to proceed through migration of a double bond (isomerized) and Diels-Alder reaction, but the present invention is not bound by this theory.

Dimer acids to be obtained are usually a mixture of dimer acids having different structures due to the binding site of a double bond or isomerization. Although the dimer acids having different structures may be separated before they are used, the dimer acids can be used as they are. Further, the dimer acid to be obtained may contain a small amount of monomer acid (for example, 3% by weight or smaller, in particular, 1% by weight or smaller), a polymer acid of a trimer or higher acid (for example, 3% by weight or smaller, in particular, 1% by weight or smaller) or the like.

The term “hydrogenated dimer acid” herein refers to a saturated dicarboxylic acid obtained by hydrogenating a carbon-carbon double bond of the above-mentioned dimer acid.

When, for the above-mentioned dimer acid, a dimer acid whose number of carbon atoms is 36 manufactured by linoleic acid and linoleic acid or oleic acid is used as a raw material, the structure of the principal component of a hydrogenated dimer acid is the structure represented by the following formula (1) or (2).

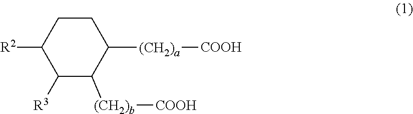

wherein R² and R³ are each independently an alkyl group, and the sum of the numbers of carbon atoms contained in R² and R³, a and b is 28 (i.e., the number of carbon atoms contained in R²+the number of carbon atoms contained in R³+a+b=28).

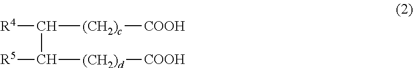

wherein R⁴ and R⁵ are each independently an alkyl group, and the sum of the numbers of carbon atoms contained in R⁴ and R⁵, c and d is 32 (i.e., the number of carbon atoms contained in R⁴+the number of carbon atoms contained in R⁵+c+d=32).

Examples of commercially available hydrogenated dimer acids include PRIPOL® 1009 (manufactured by Croda Japan KK), EMPOL® 1008 and EMPOL® 1062 (manufactured by BASF).

The term “hydrogenated dimerdiol” herein refers to a diol which includes, as a principal component, the one obtained by reducing at least one of the above-mentioned dimer acid, the above-mentioned hydrogenated dimer acid, and a lower alcohol ester thereof in the presence of a catalyst to make a carboxylic acid or carboxylate portion of the dimer acid into an alcohol, and when a raw material has a carbon-carbon double bond, the double bond is hydrogenated.

For example, when a hydrogenated dimerdiol is manufactured by reducing a hydrogenated dimer acid in which the principal component is a compound having a structure represented by the Formula (1) or (2), the structure of the principal component of the hydrogenated dimerdiol is the structure represented by the following Formula (3) or (4).

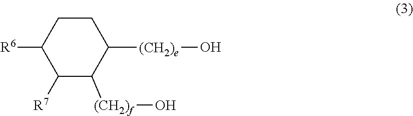

wherein R⁶ and R⁷ are each independently an alkyl group, and the sum of the number of carbon atoms included in R⁶ and R⁷, e and f is 30 (i.e., the number of carbon atoms included in R⁶+the number of carbon atoms included in R⁷+e+f=30).

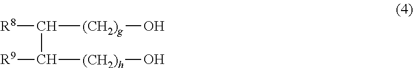

wherein R⁸ and R⁹ are each independently an alkyl group, and the sum of the numbers of carbon atoms included in R⁸ and R⁹, g and h is 34 (i.e., the number of carbon atoms included in R⁸+the number of carbon atoms included in R⁹+g+h=34).

Examples of commercially available hydrogenated dimerdiol include PRIPOL® 2033 (manufactured by Croda Japan KK) Sovermol® 908 (manufactured by BASF).

A (poly)ester polyol which may be a raw material of the component (1) which is an essential raw material component of the polymerizable composition of the invention (I) can be manufactured by condensation reaction of the above-mentioned polycarboxylic acid and polyol components in which the above-mentioned polyol is an essential component in the presence of an esterification catalyst.

Since water is removed in the above-mentioned esterification, the reaction is generally performed at a reaction temperature of about from 150 to 250° C. The reaction is generally performed under normal pressure or reduced pressure.

A (poly)ester polyol which may be a raw material of the component (1) which is an essential raw material component of the polymerizable composition of the invention (I) can also be manufactured by transesterification of a lower alkyl ester of the above-mentioned carboxylic acid and a polyol component in which the above-mentioned polyol is an essential component in the presence of a transesterification catalyst.

Since alcohol is removed in the above-mentioned transesterification, the reaction is generally performed at a reaction temperature of about from 120 to 230° C. The reaction is generally performed under normal pressure or reduced pressure.

Herein, when a (poly)ester polyol which may be a raw material of the component (1) which is an essential raw material component of the polymerizable composition of the invention (I) is manufactured, in cases where a polyol which is a raw material for (poly)ester polyol (i.e., a polyol without a —COO— bond) remains, this polyol is also included in the (poly)ester polyol.

In other words, this means that, when 8 mass % of raw material polyol remains in the (poly)ester polyol, this polyol is also included in the (poly)ester polyol.

Herein, when the component (1) which is an essential component of the polymerizable composition of the invention (I) is manufactured by newly adding a polyol other than a raw material polyol included in the (poly)ester polyol, the newly added polyol is included in the (poly)ester polyol, even the polyol is a polyol without a —COO— bond.

In other words, this means that, when a (poly)ester polyol is synthesized by using a hydrogenated dimerdiol as a raw material polyol component of the (poly)ester polyol, in cases where 8 parts by mass of the hydrogenated dimerdiol which is a raw material remain in 100 parts by mass of synthesized products, and further, 5 parts by mass of hydrogenated dimerdiol are added, whereby the component (1) is manufactured, both the raw material hydrogenated dimerdiol which remains when the component (1) is synthesized and the hydrogenated dimerdiol which is added thereafter are included in the (poly)ester polyol.

It is noted that the hydroxyl group value of a (poly)ester polyol to be used as a raw material of the polymerizable composition of the invention (I) is preferably in a range of from 20 to 100 mg KOH/g, more preferably from 25 to 80 mg KOH/g, and still more preferably from 30 to 65 mg KOH/g.

When a polyol which may be a raw material of (poly)ester polyol is used as a raw material of the component (1) which is an essential component of the polymerizable composition of the invention (I), the amount thereof, with respect to 100 parts by mass of (poly)ester polyol, is desirably 30 parts by mass or smaller, and preferably 25 parts by mass or smaller.

A (poly)carbonate polyol which may be a raw material of the component (1) which is an essential raw material component of polymerizable composition of the invention (I) is not particularly limited, as long as it is a compound having, in one molecule, one or more carbonate bonds (—OCOO—) and two or more alcoholic hydroxyl groups.

Examples of the (poly)carbonate polyol which may be a raw material of the component (1) which is an essential raw material component of polymerizable composition of the invention (I) include a (poly)carbonate polyol manufactured by using a polyol having a chain-shaped hydrocarbon chain as a raw material, a (poly)carbonate polyol manufactured by using a polyol having an alicyclic structure-containing hydrocarbon chain as a raw material, and a (poly)carbonate polyol manufactured by using a polyol having an aromatic ring structure-containing hydrocarbon chain as a raw material.

Among the polyols which may be a raw material of the (poly) carbonate polyol, preferred are polyols whose number of carbon atoms is eight or more.

Examples of the polyols whose number of carbon atoms is eight or more include 1,4-cyclohexanedimethanol, 1,2-cyclohexanedimethanol, 1,3-cyclohexanedimethanol, 2-methyl-1,1-cyclohexanedimethanol, tricyclo[5.2.1.0^{2,6}]decanedimethanol, 1,9-nonanediol, 2-methyl-1,8-octane diol, 1,10-decadiol, 1,12-dodecanediol, dimerdiol, and hydrogenated dimerdiol. Among the polyols whose number of carbon atoms is eight or more, still preferred are 1,10-decadiol, 1,12-dodecanediol, and hydrogenated dimerdiol, and most preferred is hydrogenated dimerdiol.

A (poly)carbonate polyol which may be a raw material of the component (1) which is an essential raw material component of polymerizable composition of the invention (I) can be manufactured also by transesterification of the polyol component and dialkyl carbonate, diaryl carbonate, or alkylene carbonate in the presence of a transesterification catalyst.

Since alcohol is removed in the above-mentioned transesterification, the reaction is generally performed at a reaction temperature about from 80 to 230° C. The reaction is generally performed under normal pressure or reduced pressure.

The (poly)carbonate polyol which may be a raw material of the component (1) which is an essential raw material component of polymerizable composition of the invention (I) can be manufactured also by reaction of the polyol and phosgene.

The above-mentioned reaction is generally performed at a reaction temperature of 100° C. or lower. Since hydrochloric acid is produced, a base is generally used to trap the hydrochloric acid.

Herein, when a (poly)carbonate polyol which may be a raw material of the component (1) which is an essential raw material component of the polymerizable composition of the invention (I) is manufactured, in cases where a polyol which is a raw material of the (poly)carbonate polyol (i.e., a polyol without a carbonate bond) remains, this polyol is also included in the (poly)carbonate polyol.

In other words, this means that, when 8 mass % of raw material polyol remains in the (poly)carbonate polyol, this remained polyol is also included in the (poly)carbonate polyol.

Herein, when the component (1) which is an essential component of the polymerizable composition of the invention (I) is manufactured by newly adding a polyol other than a raw material polyol included in the (poly) carbonate polyol, the newly added polyol is included in the (poly)carbonate polyol, even when the polyol is a polyol without a carbonate bond.

In other words, this means that, when the component (1) is synthesized, in cases where 8 parts by mass of the polyol which is a raw material remain in 100 parts by mass of synthesized products, and further, 5 parts by mass of polyol are added, whereby the component (1) which is an essential component of the invention (I) is manufactured, both the raw material polyol which remains when the component (1) is synthesized and the polyol which is added thereafter are included in the (poly)carbonate polyol.

It is noted that the hydroxyl group value of the (poly) carbonate polyol to be used as a raw material of the polymerizable composition of the invention (I) is preferably in a range of from 20 to 100 mg KOH/g, more preferably from 25 to 80 mg KOH/g, and still more preferably from 30 to 65 mg KOH/g.

When a polyol which may be a raw material of the (poly) carbonate polyol is used as a raw material of the component (1) which is an essential component of the invention (I), the amount thereof, with respect to 100 parts by mass of (poly)carbonate polyol, is desirably 30 parts by mass or smaller, preferably 25 parts by mass or smaller.

As mentioned above, a structural unit derived from a (poly)ester polyol or a structural unit derived from a (poly) carbonate polyol preferably includes a structural unit derived from a hydrogenated dimerdiol.

In other words, this means that the component (1) which is an essential raw material component of polymerizable composition of the invention (I) is preferably a (meth)acryloyl group-containing compound having a structural unit derived from a (poly)ester polyol having a structural unit derived from a hydrogenated dimerdiol and/or a structural unit derived from a (poly)carbonate polyol having a structural unit derived from a hydrogenated dimerdiol.

Among the (meth)acryloyl group-containing compounds having a structural unit derived from a (poly)ester polyol having a structural unit derived from a hydrogenated dimerdiol and/or a structural unit derived from a (poly)carbonate polyol having a structural unit derived from a hydrogenated dimerdiol, particularly preferred are a (meth)acryloyl group-containing compound manufactured by the reaction of a (poly)ester polyol having a structural unit derived from a hydrogenated dimerdiol and/or a (poly)carbonate polyol having a structural unit derived from a hydrogenated dimerdiol, and (meth)acrylic acid or alkyl (meth)acrylate; and a urethane (meth)acrylate synthesized using a (poly)ester polyol having a structural unit derived from a hydrogenated dimerdiol and/or a (poly)carbonate polyol having a structural unit derived from a hydrogenated dimerdiol as a raw material component.

First, description will be made regarding the (meth)acryloyl group-containing compound manufactured by the reaction of a (poly)ester polyol having a structural unit derived from a hydrogenated dimerdiol and/or a (poly) carbonate polyol having a structural unit derived from a hydrogenated dimerdiol, and (meth)acrylic acid or alkyl (meth)acrylate.

The (meth)acryloyl group-containing compound manufactured by the reaction of a (poly)ester polyol having a structural unit derived from a hydrogenated dimerdiol and/or a (poly)carbonate polyol having a structural unit derived from a hydrogenated dimerdiol, and (meth)acrylic acid or alkyl (meth)acrylate can be manufactured by condensation reaction of a (poly)ester polyol having a structural unit derived from a hydrogenated dimerdiol and/or a (poly)carbonate polyol having a structural unit derived from a hydrogenated dimerdiol and a (meth)acrylic acid in the presence of an esterification catalyst.

In the above-mentioned esterification, water is removed while performing a reaction in the presence of a polymerization inhibitor and a catalyst at a reaction temperature about from 100 to 130° C. The reaction is generally performed under normal pressure or reduced pressure.

When this reaction is performed, the charging ratio of the total number of alcoholic hydroxyl groups of the polyol including a (poly)ester polyol having a structural unit derived from a hydrogenated dimerdiol or a (poly) carbonate polyol having a structural unit derived from a hydrogenated dimerdiol and the total number of the (meth)acrylic acids is preferably in a range of from 4:3 to 3:1, and more preferably in a range of from 3:2 to 5:2. When the charging ratio is smaller than 4:3, it takes more time to complete the reaction (i.e., when (meth)acrylic acid is completely consumed), and radical polymerization may take place during the reaction, which is not preferred. When the charging ratio is larger than 3:1, the ratio of (meth)acrylate on the end of the polyol including a (poly)ester polyol having a structural unit derived from a hydrogenated dimerdiol or a (poly) carbonate polyol having a structural unit derived from a hydrogenated dimerdiol becomes too low, and as a result, the photosensitivity may deteriorate during photopolymerization of the polymerizable composition of the invention (I), which is not preferred.

The (meth)acryloyl group-containing compound manufactured by the reaction of a (poly)ester polyol having a structural unit derived from a hydrogenated dimerdiol and/or a (poly)carbonate polyol having a structural unit derived from a hydrogenated dimerdiol, and (meth)acrylic acid or alkyl (meth)acrylate can also be manufactured by performing transesterification of a (poly)ester polyol having a structural unit derived from a hydrogenated dimerdiol and/or a (poly)carbonate polyol having a structural unit derived from a hydrogenated dimerdiol, and alkyl (meth)acrylate in the presence of a transesterification catalyst.

In the above-mentioned transesterification, the generated alcohol is generally removed by performing the reaction at a reaction temperature of about from 80 to 130° C. in the presence of a polymerization inhibitor or a transesterification catalyst. The reaction is generally performed under normal pressure or reduced pressure.

When this reaction is performed, the charging ratio of the total number of alcoholic hydroxyl groups of the polyol including a (poly)ester polyol having a structural unit derived from a hydrogenated dimerdiol or a (poly) carbonate polyol having a structural unit derived from a hydrogenated dimerdiol and the total number of the alkyl (meth)acrylates is preferably in a range of from 4:3 to 3:1, and more preferably in a range of from 3:2 to 5:2. When the charging ratio is smaller than 4:3, it takes more time to complete the reaction (i.e., when alkyl (meth)acrylate is completely consumed), and radical polymerization may take place during the reaction, which is not preferred. When the charging ratio is larger than 3:1, the ratio of (meth)acrylate on the end of the polyol including a (poly)ester polyol having a structural unit derived from a hydrogenated dimerdiol or a (poly) carbonate polyol having a structural unit derived from a hydrogenated dimerdiol becomes too low, and as the result, the photosensitivity may deteriorate during photopolymerization of the polymerizable composition of the invention (I), which is not preferred.

In these reactions, a (poly)ester polyol having a structural unit derived from a hydrogenated dimerdiol or a (poly)carbonate polyol having a structural unit derived from a hydrogenated dimerdiol may be used singly, or a (poly)ester polyol having a structural unit derived from a hydrogenated dimerdiol and a (poly)carbonate polyol having a structural unit derived from a hydrogenated dimerdiol may be used in combination.

Next, description will be made regarding a urethane (meth)acrylate synthesized using a (poly)ester polyol having a structural unit derived from a hydrogenated dimerdiol and/or a (poly)carbonate polyol having a structural unit derived from a hydrogenated dimerdiol as a raw material component.

A urethane (meth)acrylate synthesized by using a (poly)ester polyol having a structural unit derived from a hydrogenated dimerdiol and/or a (poly)carbonate polyol having a structural unit derived from a hydrogenated dimerdiol as raw material component is generally synthesized by either of the following two methods.

A first method is a method in which a polyol component including a (poly)ester polyol having a structural unit derived from a hydrogenated dimerdiol and/or a (poly)carbonate polyol having a structural unit derived from a hydrogenated dimerdiol, an organic polyisocyanate compound and a hydroxyl group-containing (meth)acrylate are allowed to react.

A second method is a method in which a polyol component including a (poly)ester polyol having a structural unit derived from a hydrogenated dimerdiol and/or a (poly)carbonate polyol having a structural unit derived from a hydrogenated dimerdiol, and an isocyanato group-containing (meth)acrylate are allowed to react.

Hereafter, the first method will be described.

The polyol component including a (poly)ester polyol having a structural unit derived from a hydrogenated dimerdiol and/or a (poly)carbonate polyol having a structural unit derived from a hydrogenated dimerdiol may be one or more polyols including either or both of a (poly)ester polyol having a structural unit derived from a hydrogenated dimerdiol and a (poly)carbonate polyol having a structural unit derived from a hydrogenated dimerdiol.

The organic polyisocyanate compound is not particularly limited, as long as it is an organic compound having, in one molecule, two or more isocyanato groups. Specific examples thereof include 1,4-cyclohexane diisocyanate, isophorone diisocyanate, methylene bis(4-cyclohexyl isocyanate), 1,3-bis(isocyanatomethyl)cyclohexane, 1,4-bis(isocyanatomethyl)cyclohexane, 2,4-tolylenediisocyanate, 2,6-tolylenediisocyanate, diphenylmethane-4,4′-diisocyanate, 1,3-xylylene diisocyanate, 1,4-xylylene diisocyanate, lysine triisocyanate, lysine diisocyanate, hexamethylene diisocyanate, 2,4,4-trimethyl hexamethylene diisocyanate, 2,2,4-trimethylhexanemethylene diisocyanate and norbornane diisocyanate. These may be used singly or in combination of two or more thereof.

The component (1) which is an essential component of the polymerizable composition of the invention (I) desirably has a low viscosity in view of the degree of freedom for the subsequent blending. Examples of an organic polyisocyanate compound which meets this purpose preferably include 1,3-bis(isocyanatomethyl)cyclohexane, 1,4-bis(isocyanatomethyl)cyclohexane, 2,4,4-trimethyl hexamethylene diisocyanate, 2,2,4-trimethylhexanemethylene diisocyanate, 1,6-hexamethylene diisocyanate and norbornane diisocyanate, and further preferably include 1,3-bis(isocyanatomethyl)cyclohexane, 2,4,4-trimethyl hexamethylene diisocyanate and 2,2,4-trimethylhexanemethylene diisocyanate, and most preferably include 2,4,4-trimethyl hexamethylene diisocyanate and 2,2,4-trimethylhexanemethylene diisocyanate.

The hydroxyl group-containing (meth)acrylate is not particularly limited, as long as it is a (meth)acrylate having, in one molecule, an alcoholic hydroxyl group. Specific examples thereof include 2-hydroxyethyl acrylate, 2-hydroxypropyl acrylate, 3-hydroxypropyl acrylate, 2-hydroxybutyl acrylate, 4-hydroxybutyl acrylate, 2-hydroxy-3-phenoxypropyl acrylate, 2-hydroxy-3-(o-phenyl phenoxy)propyl acrylate, 2-hydroxyethyl acrylamide, 2-hydroxyethyl methacrylate, 2-hydroxypropyl methacrylate, 3-hydroxypropyl methacrylate, 2-hydroxybutyl methacrylate, 4-hydroxybutyl methacrylate, 2-hydroxy-3-phenoxypropyl methacrylate, and 2-hydroxy-3-(o-phenyl phenoxy)propyl methacrylate.

Among these, in view of the polymerization rate of the component (1) which is an essential component of the invention (I), preferred are 2-hydroxyethyl acrylate, 2-hydroxypropyl acrylate, 3-hydroxypropyl acrylate, 2-hydroxybutyl acrylate, 4-hydroxybutyl acrylate, 2-hydroxy-3-phenoxypropyl acrylate, and 2-hydroxy-3-(o-phenyl phenoxy)propyl acrylate. In view of the reactivity with an isocyanate group, preferred are 2-hydroxyethyl acrylate, 3-hydroxypropyl acrylate, and 4-hydroxybutyl acrylate, and most preferred is 4-hydroxybutyl acrylate.

As a method of reacting a polyol component including a (poly)ester polyol having a structural unit derived from a hydrogenated dimerdiol and/or a (poly)carbonate polyol having a structural unit derived from a hydrogenated dimerdiol, an organic polyisocyanate compound, and a hydroxyl group-containing (meth)acrylate, a method in which a polyol component including a (poly)ester polyol having a structural unit derived from a hydrogenated dimerdiol and/or a (poly)carbonate polyol having a structural unit derived from a hydrogenated dimerdiol, an organic polyisocyanate compound and a hydroxyl group-containing (meth)acrylate in the presence or absence of a known urethanization catalyst such as dibutyl tin dilaurylate, or dioctyltin dilaurate can be employed to synthesize. In view of shortening the reaction time, the reaction is performed in the presence of a catalyst. It is noted that, since a too large amount of the catalyst may finally adversely affect the physical properties of a cured film during its use, the amount of the catalyst to be used is preferably from 0.001 to 1 parts by mass with respect to 100 parts by mass of the total amount of the polyol component including a (poly)ester polyol having a structural unit derived from a hydrogenated dimerdiol and/or a (poly) carbonate polyol having a structural unit derived from a hydrogenated dimerdiol, the organic polyisocyanate compound, and the hydroxyl group-containing (meth)acrylate.

Although the order of blending the raw materials is not particularly restricted, when the end of a compound is almost completely sealed with a compound having, in one molecule, a hydroxyl group including a hydroxyl group-containing (meth)acrylate, usually, an organic polyisocyanate compound and, as needed, a urethanization catalyst are input into a reactor and the mixture is stirred, and then a (poly)ester polyol having a structural unit derived from a hydrogenated dimerdiol and/or a (poly)carbonate polyol having a structural unit derived from a hydrogenated dimerdiol, and as needed, a polyol component other than the polyester polyol or the (poly) carbonate polyol are input successively at a temperature in the reactor of from 40° C. to 140° C., and preferably from 50° C. to 120° C., and thereafter, the resultant mixture is allowed to react at a temperature in the reactor of from 50° C. to 160° C., preferably from 60° C. to 140° C. Then, a polymerization inhibitor and, as needed, a urethanization catalyst are added thereto at a temperature in the reactor of from 30° C. to 120° C., preferably from 50° C. to 100° C., and hydroxyl group-containing (meth)acrylate is input by dropping. During dropping, the temperature in the reactor is preferably maintained at from 30° C. to 120° C., and desirably from 50° C. to 100° C. After completion of dropping, the temperature in the reactor is maintained at from 30° C. to 120° C., desirably from 50° C. to 100° C. to complete the reaction.

When only a part of the end of the compound is sealed with a compound having, in the molecule, one hydroxyl group including a hydroxyl group-containing (meth)acrylate, usually, an organic polyisocyanate compound, and, as needed, a polymerization inhibitor and/or a urethanization catalyst are input into a reactor, and the mixture is stirred, and thereafter, a hydroxyl group-containing (meth)acrylate is input by dropping at a temperature in the reactor of from 30° C. to 120° C., preferably from 50° C. to 110° C. During dropping, the temperature in the reactor is preferably maintained at from 30° C. to 120° C., desirably from 50° C. to 110° C. After completion of dropping, the temperature in the reactor is maintained at from 30° C. to 120° C., desirably from 50° C. to 110° C., to allow the reaction to proceed. Thereafter, the above-mentioned reaction product is input into a reactor in which a (poly)ester polyol having a structural unit derived from a hydrogenated dimerdiol and/or a (poly) carbonate polyol having a structural unit derived from a hydrogenated dimerdiol, and as needed, a polyol component other than the polyester polyol or (poly) carbonate polyol are placed while the mixture is stirred so that the temperature in the reactor can be maintained at from 30° C. to 120° C., preferably from 50° C. to 100° C. After the reaction product is input, the temperature in the reactor is maintained at from 30° C. to 120° C., desirably from 50° C. to 100° C., to complete the reaction.

When the component (1) which is an essential component of the invention (I) is used, in cases where increase in the viscosity of an oligomer is suppressed or the volume shrinkage rate during polymerization needs to be reduced, the oligomer is desirably to be an oligomer in which only a part of the end of the compound is sealed with a compound having, in the molecule, one hydroxyl group including a hydroxyl group-containing (meth)acrylate.

The charging mole ratio of the raw materials (i.e., (the total number of hydroxyl groups when the number of (poly)ester polyols having a structural unit derived from a hydrogenated dimerdiol to be used, the number of (poly) carbonate polyols having a structural unit derived from a hydrogenated dimerdiol to be used, and the number of polyols other than the polyester polyol or (poly)carbonate polyol to be used are combined)/(the total number of isocyanato groups of the organic polyisocyanate compound to be used)/(the total number of hydroxyl groups when the number of compounds having, in the molecule, one hydroxyl group including a hydroxyl group-containing (meth)acrylate to be used is combined)) is adjusted depending on the molecular weight of an objective polyurethane.

It is noted that, when the end of the compound is almost completely sealed with a compound having, in the molecule, one hydroxyl group including a hydroxyl group-containing (meth)acrylate, the total number of isocyanato groups of the organic polyisocyanate compound to be used) needs to be larger than the total number of hydroxyl groups when the number of (poly)ester polyols having a structural unit derived from a hydrogenated dimerdiol to be used, the number of (poly)carbonate polyols having a structural unit derived from a hydrogenated dimerdiol to be used, and the number of polyols other than the polyester polyol or (poly)carbonate polyol to be used are combined.

In this case, when the ratio of the total number of hydroxyl groups when the number of (poly)ester polyols having a structural unit derived from a hydrogenated dimerdiol to be used, the number of (poly)carbonate polyols having a structural unit derived from a hydrogenated dimerdiol to be used, and the number of polyols other than the polyester polyol or (poly) carbonate polyol to be used are combined to the total number of isocyanato groups of the organic polyisocyanate compound to be used is closer to 1.0, the molecular weight becomes larger, and when the ratio becomes far from and smaller than 1.0, the molecular weight becomes smaller.

Although the charging mole ratio of the raw materials is not particularly limited, the ratio of the total number of isocyanato groups in the organic polyisocyanate compound to the total number of hydroxyl groups when the number of (poly)ester polyols having a structural unit derived from a hydrogenated dimerdiol to be used, the number of (poly)carbonate polyols having a structural unit derived from a hydrogenated dimerdiol to be used, and the number of polyols other than the polyester polyol or (poly)carbonate polyol to be used are combined is preferably 1.5:1 or larger.

When the ratio is smaller than 1.5:1, the viscosity may become too high, which is not preferred.

When only a part of the end of the compound is sealed with a compound having, in the molecule, one hydroxyl group including a hydroxyl group-containing (meth)acrylate, the total number of hydroxyl groups when the number of (poly)ester polyols having a structural unit derived from a hydrogenated dimerdiol to be used, the number of (poly)carbonate polyols having a structural unit derived from a hydrogenated dimerdiol to be used, the number of polyols other than the polyester polyol or (poly) carbonate polyol to be used, and the number of compounds having, in the molecule, one hydroxyl group including a hydroxyl group-containing (meth)acrylate to be used needs to be larger than the total number of isocyanato groups in the organic polyisocyanate compound to be used.

It is noted that, in this case, the ratio of the total number of hydroxyl groups when the number of (poly)ester polyols having a structural unit derived from a hydrogenated dimerdiol to be used, the number of (poly) carbonate polyols having a structural unit derived from a hydrogenated dimerdiol to be used, the number of polyols other than the polyester polyol or (poly) carbonate polyol to be used, and the number of compounds having, in the molecule, one hydroxyl group including a hydroxyl group-containing (meth)acrylate to be used to the total number of isocyanato groups in the organic polyisocyanate compound to be used is preferably 2:1 or lower.

When the ratio is higher than 2:1, the number of molecules without an acryloyl group is increased, and the shape retaining properties of the polymer after polymerization may deteriorate, which is not preferred.

When a urethane (meth)acrylate which is synthesized using a (poly)ester polyol having a structural unit derived from a hydrogenated dimerdiol and/or a (poly)carbonate polyol having a structural unit derived from a hydrogenated dimerdiol as a raw material component is synthesized, a urethane (meth)acrylate which does not have a structural unit derived from a hydrogenated dimerdiol may be manufactured. Herein, the urethane (meth)acrylate which does not have a structural unit derived from a hydrogenated dimerdiol is defined to be excluded in the component (1) which is an essential component of the invention (I). For example, when a urethane (meth)acrylate which is the component (1) is manufactured by using a (poly)ester polyol having a structural unit derived from a hydrogenated dimerdiol, 1,3-bis(isocyanatomethyl)cyclohexane and 2-hydroxyethyl acrylate, the compound of the following Formula (5) which is a urethane (meth)acrylate which does not have a structural unit derived from a hydrogenated dimerdiol is also manufactured.

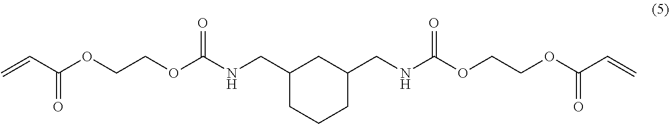

However, herein, the compound of Formula (5) does not have a structural unit derived from a hydrogenated dimerdiol, which means that the compound is not included in the component (1).

The amount of the component (1) to be used is preferably, with respect to the total amount of the polymerizable composition of the invention (I), from 20 to 60 mass %, further preferably, from 25 to 50 mass %, and particularly preferably from 30 to 45 mass %. When the amount of the component (1) to be used is less than 20 mass % with respect to the total amount of the polymerizable composition of the invention (I), the volume shrinkage rate during polymerization of the polymerizable composition of the invention (I) may become high or it may become difficult to polymerize the polymerizable composition of the invention (I), which is not preferred. When the amount of the component (1) to be used is larger than 60 mass % with respect to the total amount of the polymerizable composition of the invention (I), the viscosity of the polymerizable composition of the invention (I) may become high, which is not preferred.

Next, the second method will be described.

The second method is a method in which a polyol component including a (poly)ester polyol having a structural unit derived from a hydrogenated dimerdiol and/or a (poly)carbonate polyol having a structural unit derived from a hydrogenated dimerdiol, and an isocyanato group-containing (meth)acrylate are allowed to react.

As mentioned above, the polyol component including a (poly)ester polyol having a structural unit derived from a hydrogenated dimerdiol and/or a (poly)carbonate polyol having a structural unit derived from a hydrogenated dimerdiol may be one or more kinds of polyols including either or both of a (poly)ester polyol having a structural unit derived from a hydrogenated dimerdiol and a (poly)carbonate polyol having a structural unit derived from a hydrogenated dimerdiol.

The isocyanato group-containing (meth)acrylate is not particularly limited, as long as it is a (meth)acrylate having, in one molecule, an isocyanato group.

Examples of the isocyanato group-containing (meth)acrylate include 2-isocyanatoethyl acrylate and 2-isocyanatoethyl methacrylate.

All of hydroxyl groups in the polyol components including a (poly)ester polyol having a structural unit derived from a hydrogenated dimerdiol and/or a (poly) carbonate polyol having a structural unit derived from a hydrogenated dimerdiol may be reacted with an isocyanato group-containing (meth)acrylate, or only a part of hydroxyl groups in the polyol components including a (poly)ester polyol having a structural unit derived from a hydrogenated dimerdiol and/or a (poly) carbonate polyol having a structural unit derived from a hydrogenated dimerdiol may be reacted with an isocyanato group-containing (meth)acrylate and a part of the hydroxyl groups may remain unreacted.

When all of hydroxyl groups in the polyol components including a (poly)ester polyol having a structural unit derived from a hydrogenated dimerdiol and/or a (poly) carbonate polyol having a structural unit derived from a hydrogenated dimerdiol are reacted with an isocyanato group-containing (meth)acrylate, the ratio of the total number of hydroxyl groups when the number of (poly)ester polyols having a structural unit derived from a hydrogenated dimerdiol to be used, the number of (poly) carbonate polyols having a structural unit derived from a hydrogenated dimerdiol to be used, and the number of polyols other than the polyester polyol or (poly) carbonate polyol to be used are combined with the total number of isocyanato groups in the isocyanato group-containing (meth)acrylate to be used needs to be 1 or higher.

When only a part of hydroxyl groups in the polyol components including a (poly)ester polyol having a structural unit derived from a hydrogenated dimerdiol and/or a (poly)carbonate polyol having a structural unit derived from a hydrogenated dimerdiol is reacted with an isocyanato group-containing (meth)acrylate and a part of the hydroxyl groups remains unreacted, blending needs to be performed such that the total number of hydroxyl groups when the number of (poly)ester polyols having a structural unit derived from a hydrogenated dimerdiol to be used, the number of (poly)carbonate polyols having a structural unit derived from a hydrogenated dimerdiol to be used, and the number of polyols other than the polyester polyol or (poly)carbonate polyol to be used are combined is smaller than the total number of isocyanato groups in the isocyanato group-containing (meth)acrylate to be used.

In order to keep the volume shrinkage rate during the polymerization of the polymerizable composition of the invention (I) low, the ratio of the total number of hydroxyl groups when the number of (poly)ester polyols having a structural unit derived from a hydrogenated dimerdiol to be used, the number of (poly)carbonate polyols having a structural unit derived from a hydrogenated dimerdiol to be used, and the number of polyols other than the polyester polyol or (poly) carbonate polyol to be used are combined to the total number of isocyanato groups in the isocyanato group-containing (meth)acrylate to be used is preferably in a range of from 1.5:1 to 2.5:1, and further preferably in a range of from 1.7:1 to 2.3:1.

Although the manufacturing method is not particularly restricted, in general, a polyol component including a (poly)ester polyol having a structural unit derived from a hydrogenated dimerdiol and/or a (poly) carbonate polyol having a structural unit derived from a hydrogenated dimerdiol, polymerization inhibitor, and as needed, a urethanization catalyst or an antioxidant is added, and input into a reactor, and stirring is started, and then the temperature in the reactor is raised to from 40° C. to 120° C., preferably from 50° C. to 100° C. Thereafter, an isocyanato group-containing (meth)acrylate is input by dropping. During dropping, the temperature in the reactor is controlled at from 40° C. to 130° C., preferably from 50° C. to 110° C. After completion of dropping, the temperature in the reactor is maintained at from 40° C. to 120° C., preferably from 50° C. to 100° C. while continuing stirring, to complete the reaction.

Next, the component (2) which is an essential component of the invention (I) will be described.

The component (2) which is an essential component of the invention (I) is a (meth)acryloyl group-containing compound having a hydrocarbon group having nine or more carbon atoms. Examples of the hydrocarbon group having nine or more carbon atoms include an aliphatic hydrocarbon group having nine or more carbon atoms and an alicyclic hydrocarbon group having nine or more carbon atoms. Examples of the former include a nonyl group, a decyl group, an isodecyl group, an undecyl group, a dodecyl group, a 2-heptyl undecyl group, and an isooctadecyl group. Examples of the latter include a bornyl group, an isobornyl group, a dicyclopentanyl group, a dicylopentenyl group, a propylcyclohexyl group, a butylcyclohexyl group, and a tert-butylcyclohexyl group.

Examples of the (meth)acryloyl group-containing compound having a hydrocarbon group having nine or more carbon atoms include a (meth)acryloyl group-containing compound having a cycloaliphatic group such as isobornyl acrylate, dicylopentenyl acrylate, dicylopentenyl oxyethyl acrylate, dicyclopentanyl acrylate, dicyclopentanyl ethyl acrylate, 4-tert-butyl cyclohexyl acrylate, isobornyl methacrylate, dicylopentenyl methacrylate, dicylopentenyl oxyethyl methacrylate, dicyclopentanyl methacrylate, dicyclopentanyl ethyl methacrylate, or 4-tert-butyl cyclohexyl methacrylate, and a (meth)acryloyl group-containing compound having a chain aliphatic group such as lauryl acrylate, isononyl acrylate, 2-propyl heptyl acrylate, 4-methyl-2-propyl hexyl acrylate, lauryl methacrylate, isononyl methacrylate, 2-propyl heptyl methacrylate, or 4-methyl-2-propyl hexyl methacrylate.

Among these, in view of resistance to thermal coloration, preferred are isobornyl acrylate, dicyclopentanyl acrylate, dicyclopentanyl oxyethyl acrylate, isobornyl methacrylate, dicyclopentanyl methacrylate, dicyclopentanyl ethyl methacrylate, lauryl acrylate, isononyl acrylate, 2-propyl heptyl acrylate, 4-methyl-2-propyl hexyl acrylate, lauryl methacrylate, isononyl methacrylate, 2-propyl heptyl methacrylate, and 4-methyl-2-propyl hexyl methacrylate; in view of dilution efficiency, further preferred are lauryl acrylate, isononyl acrylate, 2-propyl heptyl acrylate, 4-methyl-2-propyl hexyl acrylate, isononyl methacrylate, 2-propyl heptyl methacrylate, and 4-methyl-2-propyl hexyl methacrylate; and in view of the photopolymerization rate, particularly preferred are lauryl acrylate, isononyl acrylate, 2-propyl heptyl acrylate, and 4-methyl-2-propyl hexyl acrylate.

The amount of the component (2) to be used is, with respect to the total amount of the polymerizable composition of the invention (I), preferably from 10 to 30 mass %, further preferably, from 13 to 25 mass %, and particularly preferably from 15 to 22 mass %. When the amount of the component (2) to be used is less than 10 mass % with respect to the total amount of the polymerizable composition of the invention (I), the viscosity of the polymerizable composition of the invention (I) may become high, which is not preferred. When the amount of the component (2) to be used is larger than 30 mass % with respect to the total amount of the polymerizable composition of the invention (I), the volume shrinkage rate during polymerization of the polymerizable composition of the invention (I) may become high, which is not preferred.

Next, the component (3) which is an essential component of the polymerizable composition of the invention (I) will be described.

The component (3) which is an essential component of the invention (I) is a photopolymerization initiator.

A photopolymerization initiator of the component (3) is not particularly limited, as long as it is a compound which generates a radical contributing to the initiation of radical polymerization by irradiation of light such as near infrared light, visible light, or UV light.

Specific examples of the photopolymerization initiator of the component (3) include acetophenone, 2,2-dimethoxy-2-phenyl acetophenone, diethoxyacetophenone, 1-hydroxycyclohexyl phenyl ketone, 1,2-hydroxy-2-methyl-1-phenyl propane-1-one, α-hydroxycyclohexyl phenyl ketone, 2-hydroxy-2-methyl-1-phenyl propane-1-one, 2-hydroxy-2-methyl-1-(4-isopropylphenyl)propane-1-one, 2-hydroxy-2-methyl-1-(4-dodecylphenyl)propane-1-one, and 2-hydroxy-2-methyl-1-[(2-hydroxyethoxy)phenyl]propanone, benzophenone, 2-methylbenzophenone, 3-methylbenzophenone, 4-methylbenzophenone, 4-methoxybenzophenone, 2-chlorobenzophenone, 4-chlorobenzophenone, 4-bromobenzophenone, 2-carboxybenzophenone, 2-ethoxycarbonyl benzophenone, 4-benzoyl-4′-methyl diphenyl sulfide, benzophenone tetracarboxylic acid or a tetramethyl ester thereof, a 4,4′-bis(dialkylamino)benzophenone (such as 4,4′-bis(dimethylamino)benzophenone, 4,4′-bis(dicyclohexylamino)benzophenone, 4,4′-bis(diethylamino)benzophenone, or 4,4′-bis(dihydroxyethylamino)benzophenone), 4-methoxy-4′-dimethylamino benzophenone, 4,4′-dimethoxybenzophenone, 4-dimethylamino benzophenone, 4-dimethylamino acetophenone, benzil, anthraquinone, 2-t-butylanthraquinone, 2-methylanthraquinone, phenanthraquinone, fluorenone, 2-benzil-2-dimethylamino-1-(4-morpholinophenyl)-1-butanone, 2-(dimethylamino)-2-[(4-methyl phenyl)methyl]-1-[4-(4-morpholinyl)phenyl]-1-butanone, 2-methyl-1-[4-(methylthio)phenyl]-2-morpholino-1-propanone, 2-hydroxy-2-methyl-[4-(1-methylvinyl)phenyl]propanol oligomer, benzoin, a benzoin ether (such as benzoin methylether, benzoin ethylether, benzoin propylether, benzoin isopropylether, benzoin isobutylether, benzoin phenylether, or benzildimethylketal), acridone, chloroacridone, N-methylacridone, N-butylacridone, N-butyl-chloroacridone, 2,4,6-trimethylbenzoyl diphenylphosphine oxide, 2,6-dimethoxybenzoyl diphenylphosphine oxide, 2,6-dichlorobenzoyl diphenylphosphine oxide, 2,4,6-trimethylbenzoyl methoxyphenylphosphine oxide, 2,4,6-trimethylbenzoyl ethoxy phenylphosphine oxide, 2,3,5,6-tetramethylbenzoyl diphenylphosphine oxide, and benzoyl di-(2,6-dimethyl phenyl)phosphonate. Examples of a bisacyl phosphine oxide include bis-(2,6-dichlorobenzoyl)phenylphosphine oxide, bis-(2,6-dichlorobenzoyl)-2,5-dimethylphenylphosphine oxide, bis-(2,6-dichlorobenzoyl)-4-propylphenylphosphine oxide, bis-(2,6-dichlorobenzoyl)-1-naphthyl phosphine oxide, bis-(2,6-dimethoxybenzoyl)phenylphosphine oxide, bis-(2,6-dimethoxybenzoyl)-2,4,4-trimethylpentyl phosphine oxide, bis-(2,6-dimethoxybenzoyl)-2,5-dimethylphenylphosphine oxide, bis-(2,4,6-trimethyl benzoyl)phenylphosphine oxide, (2,5,6-trimethyl benzoyl)-2,4,4-trimethylpentyl phosphine oxide, 2-isopropylthioxanthone, 4-isopropylthioxanthone, 2,4-diethylthioxanthone, 2,4-dichlorothioxanthone, and 1-chloro-4-propoxythioxanthone.

As a photopolymerization initiator, a metallocene compound may also be employed. As the metallocene compound, a transition element represented by Fe, Ti, V, Cr, Mn, Co, Ni, Mo, Ru, Rh, Lu, Ta, W, Os, Ir, or the like can be used as a central metal, and examples of the metallocene compound include bis(η5-2,4-cyclopentadien-1-yl)-bis[2,6-difluoro-3-(pyrrole-1-yl)phenyl] titanium.

These photopolymerization initiators can be used singly or in combination of two or more thereof.

Among these, preferred are 2-hydroxy-2-methyl-1-phenyl propane-1-one, 1-hydroxycyclohexyl phenyl ketone, 2,4,6-trimethylbenzoyl diphenylphosphine oxide, and 2,3,5,6-tetramethylbenzoyl diphenylphosphine oxide; particularly preferred are 1-hydroxycyclohexyl phenyl ketone and 2,4,6-trimethylbenzoyl diphenylphosphine oxide; and most preferred is a single use of 2,4,6-trimethylbenzoyl diphenylphosphine oxide or a use of 1-hydroxycyclohexyl phenyl ketone and 2,4,6-trimethylbenzoyl diphenylphosphine oxide in combination.

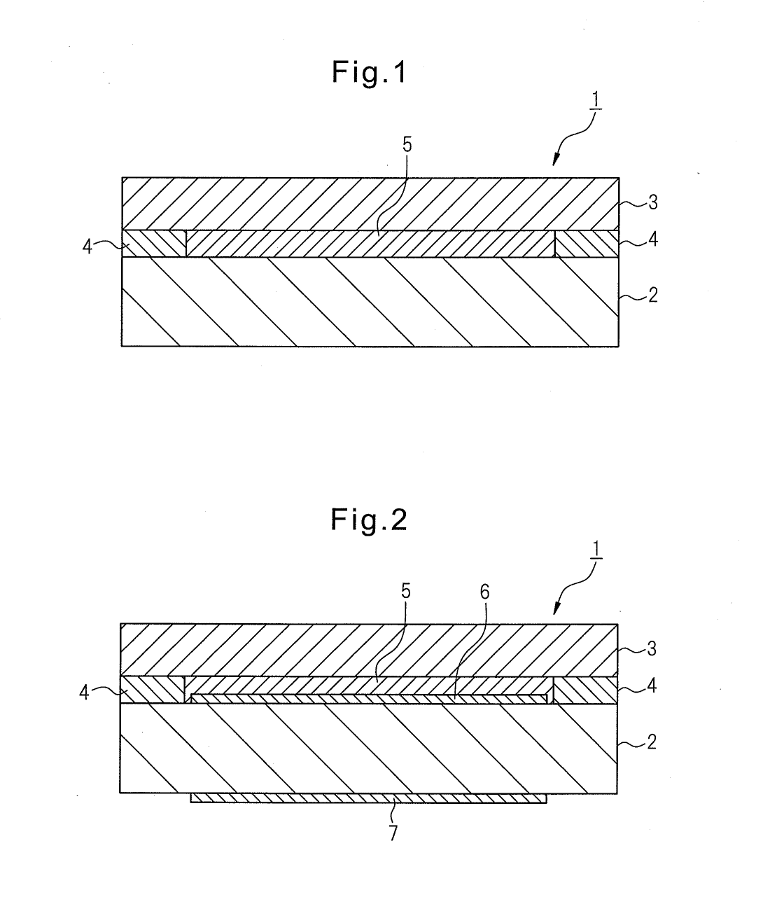

In many cases, a protection unit 3 in FIG. 1 or FIG. 2 is provided with a function of cutting a UV light region from the viewpoint of protecting a display unit 2 from UV light. In this case, 2,4,6-trimethylbenzoyl diphenylphosphine oxide or 2,3,5,6-tetramethylbenzoyl diphenylphosphine oxide which is a photopolymerization initiator photosensitive even in a visible light region is preferably used, and particularly preferably 2,4,6-trimethylbenzoyl diphenylphosphine oxide is used.

The amount of the component (3) to be used is, with respect to the total amount of the polymerizable composition of the invention (I), preferably from 0.1 to 4.0 mass %, further preferably from 0.3 to 3.0 mass %, and particularly preferably from 0.5 to 2.0 mass %. When the amount of the component (3) to be used is smaller than 0.1 mass % with respect to the total amount of the polymerizable composition of the invention (I), the polymerization initiation performance of the polymerization initiator may become insufficient, which is not preferred. When the amount of the component (3) to be used is larger than 4.0 mass % with respect to the total amount of the polymerizable composition of the invention (I), a polymer of the below-mentioned invention (II) may tend to be colored when placed under a high temperature environment, which is not preferred.

Further, the polymerizable composition of the invention (I) may include the component (4) below, which is preferred.

Component (4): at least one selected from the group consisting of hydrogenated petroleum resins, hydrogenated terpene resins, hydrogenated rosin ester, hydrogenated polybutadiene and hydrogenated polyisoprene

A hydrogenated petroleum resin is a resin obtained by reducing a petroleum resin with hydrogen. Examples of a petroleum resin which is a raw material of a hydrogenated petroleum resin include an aliphatic petroleum resin, an aromatic petroleum resin, an aliphatic-aromatic copolymerization petroleum resin, an alicyclic petroleum resin, a dicyclopentadiene resin and a modified product thereof such as a hydrogenated product thereof. As a synthetic petroleum resin, a C5 petroleum resin or a C9 petroleum resin may be used.

A hydrogenated terpene resin is a resin obtained by reducing a terpene resin with hydrogen. Examples of the terpene resin which is a raw material of the hydrogenated terpene resin include a β-pinene resin, an α-pinene resin, a β-limonene resin, an α-limonene resin, a pinene-limonene copolymer resin, a terpene-phenol resin, and an aromatic modified terpene resin. Many of these terpene resins do not have a polar group.

A hydrogenated rosin ester is a resin obtained by esterifying a hydrogenated rosin obtained by hydrogenation of a rosin resin, or reducing a rosin ester obtained by esterifying a rosin with hydrogen. Examples of a rosin resin tackifier include a modified rosin such as gum rosin, tall oil rosin, wood rosin, disproportionated rosin, polymerized rosin, or maleated rosin.

A hydrogenated polybutadiene is a compound obtained by reducing a polybutadiene with hydrogen. Generally, those obtained by reducing 1,2-polybutadiene with hydrogen are preferred, since it does not have crystal properties. When a hydrogenated polybutadiene is used for a polymerizable composition of the invention (I), the number-average molecular weight thereof is preferably 30000 or lower in order that the viscosity of the polymerizable composition of the invention (I) does not become too high.

A hydrogenated polyisoprene is a compound obtained by reducing a polyisoprene with hydrogen. The number-average molecular weight thereof is preferably 30000 or lower in order that the viscosity of the polymerizable composition of the invention (I) does not become too high.

These compound of the component (4) may be used singly or in combination of two or more thereof.

Among these, preferred are a hydrogenated petroleum resin and a hydrogenated terpene resin; and further preferred is a hydrogenated terpene resin.

Among the hydrogenated terpene resins, a terpene copolymer resin which does not have an aromatic ring such as a β-pinene resin, an α-pinene resin, a β-limonene resin, an α-limonene resin, or a pinene-limonene copolymer resin is preferred, since coloration thereof is small when stored in a high temperature environment.

When the component (4) is used as a polymerizable composition of the invention (I), regarding the amount of the component (4) to be used, although it depends on the component in the compositions other than the component (4), the total amount of the component (1) and the component (4) is, with respect to the total amount of the polymerizable composition of the invention (I), preferably from 60 to 90 mass %, further preferably from 65 to 87 mass %, and particularly preferably from 67 to 85 mass %. When the total amount of the component (1) and the component (4) is smaller than 60 mass % with respect to the total amount of the polymerizable composition of the invention (I), the volume shrinkage rate during polymerization may become high, which is not preferred. When the total amount of the component (1) and the component (4) is larger than 90 mass % with respect to the total amount of the polymerizable composition of the invention (I), the viscosity of the polymerizable composition of the invention (I) may become high, which is not preferred.

Further, the polymerizable composition of the invention (I) can include the component (5) below, which is preferred.

Component (5): (meth)acryloyl group-containing compound having an alcoholic hydroxyl group

The component (5) is not particularly limited, as long as it is a compound having, in the same molecule, an alcoholic hydroxyl group and a (meth)acryloyl group.

Examples of a (meth)acryloyl group-containing compound having an alcoholic hydroxyl group include 2-hydroxyethyl acrylate, 2-hydroxypropyl acrylate, 3-hydroxypropyl acrylate, 2-hydroxybutyl acrylate, 4-hydroxybutyl acrylate, 2-hydroxy-3-phenoxypropyl acrylate, 2-hydroxy-3-(o-phenyl phenoxy)propyl acrylate, 2-hydroxyethyl acrylamide, 2-hydroxyethyl methacrylate, 2-hydroxypropyl methacrylate, 3-hydroxypropyl methacrylate, 2-hydroxybutyl methacrylate, 4-hydroxybutyl methacrylate, 2-hydroxy-3-phenoxypropyl methacrylate, and 2-hydroxy-3-(o-phenyl phenoxy)propyl methacrylate.

Among these, in view of compatibility when used as the polymerizable composition of the invention (I), preferred are 2-hydroxybutyl acrylate, 4-hydroxybutyl acrylate, 2-hydroxy-3-phenoxypropyl acrylate, 2-hydroxy-3-(o-phenyl phenoxy)propyl acrylate, 2-hydroxypropyl methacrylate, 3-hydroxypropyl methacrylate, 2-hydroxybutyl methacrylate, and 4-hydroxybutyl methacrylate; more preferred are 4-hydroxybutyl acrylate, 2-hydroxypropyl methacrylate, 3-hydroxypropyl methacrylate, 2-hydroxybutyl methacrylate, and 4-hydroxybutyl methacrylate; and most preferred is 2-hydroxypropyl methacrylate.

Further, the polymerizable composition of the invention (I) can include the component (6) below, which is preferred.

Component (6): at least one selected from the group consisting of a hydrogenated polybutadiene polyol and a hydrogenated polyisoprene polyol

The component (6) is used in order to increase compatibility of the component (1), the component (4) and the component (5). In addition, the component is suitably used when there is a need for reducing the dielectric constant of a polymer of the below-mentioned invention (II), or for the purpose of further reducing the volume shrinkage rate during polymerization.

A hydrogenated polybutadiene polyol is a compound obtained by reducing a polybutadiene polyol with hydrogen. Generally, those obtained by reducing 1,2-polybutadiene polyol with hydrogen are preferred, since it does not have crystal properties. Examples of the hydrogenated polybutadiene diol include GI-1000, GI-2000 and GI-3000 manufactured by Nippon Soda Co., Ltd.

A hydrogenated polyisoprene polyol is a compound obtained by reducing a polyisoprene polyol with hydrogen. An example of the hydrogenated polyisoprene polyol includes Epol manufactured by Idemitsu Kosan Co., Ltd.

Preferred usage of the component (6) is that at least one of a hydrogenated polybutadiene polyol and a hydrogenated polyisoprene polyol and at least one of a hydrogenated petroleum resin and a hydrogenated terpene resin are used in combination. Most preferably, at least one of a hydrogenated polybutadiene polyol and a hydrogenated polyisoprene polyol, and a hydrogenated terpene resin are used in combination.

The volume shrinkage rate of the polymerizable composition of the invention (I) during polymerization is preferably 4.0% or lower, and further preferably 3.0% or lower. When the volume shrinkage rate of the polymerizable composition of the invention (I) during polymerization is higher than 4.0%, the internal stress which is accumulated in a polymer when the polymerizable composition is polymerized becomes too large, and a deformation is generated at the interface between a polymer layer 5 and the display unit 2 or the protection unit 3, which is not preferred.

The tensile elasticity of the polymer at 23° C. is preferably 1×10⁷ Pa or lower, and further preferably from 1×10³ to 1×10⁶ Pa.

The tensile elasticity herein is a value which is obtained by conducting a test using a drawing speed of 500 mm/min.

When the tensile elasticity of the polymer at 23° C. is higher than 1×10⁷ Pa, a deformation may be generated on an image-display unit and a protection unit during polymerization of the polymerizable composition by the influence of a stress due to the volume shrinkage, which is not preferred.

The viscosity of the polymerizable composition of the invention (I) at 25° C. is preferably 5000 mPa·s or lower, and further preferably 4000 mPa·s or lower.

The viscosity herein is a value obtained by the measurement using a Cone/Plate type viscometer (manufactured by Brookfield, type: DV-II+Pro, spindle model: CPE-42), at a temperature of 25.0° C., and at a number of revolutions of 10 rpm.

When the viscosity of the polymerizable composition of the invention (I) at 25° C. is higher than 5000 mPa·s, in cases where the polymerizable composition of the invention (I) is applied by drawing-application using a dispenser, spread after application is supressed, and as a result, the composition does not spread at a required location in a uniform thickness, which is not preferred.

To the polymerizable composition of the invention (I), a polymerization inhibitor, an antioxidant, an antifoaming agent, a modifying agent or the like may be added, as needed.

The polymerization inhibitor is not particularly restricted, and examples thereof include phenothiazine, hydroquinone, p-methoxyphenol, p-benzoquinone, naphthoquinone, phenanthraquinone, toluquinone, 2,5-diacetoxy-p-benzoquinone, 2,5-dicaproxy-p-benzoquinone, 2,5-acyloxy-p-benzoquinone, p-t-butyl catechol, 2,5-di-t-butylhydroquinone, p-tert-butyl catechol, mono-t-butylhydroquinone, 2,5-di-t-amyl hydroquinone, di-t-butyl•para-cresol hydroquinone monomethyl ether, alpha-naphthol, acetamidine acetate, acetamidine sulfate, phenylhydrazine hydrochloride, hydrazine hydrochloride, trimethylbenzylammonium chloride, lauryl pyridinium chloride, cetyl trimethyl ammonium chloride, phenyl trimethyl ammonium chloride, trimethylbenzylammonium oxalate, di(trimethylbenzylammonium)oxalate, trimethylbenzylammonium malate, trimethylbenzylammonium tartarate, trimethylbenzylammonium glycolate, phenyl-β-naphthylamine, parabenzil aminophenol, di-β-naphthyl paraphenylene diamine, dinitrobenzene, trinitrotoluene, picric acid, cyclohexanone oxime, pyrogallol, tannic acid, resorcinol, triethylamine hydrochloride, dimethylaniline hydrochloride and dibutylamine hydrochloride.

These may be used singly or in appropriate combination of two or more thereof.

Among these, hydroquinone, p-methoxyphenol, p-benzoquinone, naphthoquinone, phenanthraquinone, 2,5-diacetoxy-p-benzoquinone, 2,5-dicaproxy-p-benzoquinone, 2,5-acyloxy-p-benzoquinone, p-t-butyl catechol, 2,5-di-t-butylhydroquinone, p-tert-butyl catechol, mono-t-butylhydroquinone, 2,5-di-t-amyl hydroquinone, di-t-butyl•para-cresol hydroquinone monomethyl ether and phenothiazine are suitably employed.

Usually, the polymerization inhibitor can be adjusted such that the amount thereof added is 0.01 to 5 mass % with respect to the total amount of the polymerizable composition of the invention (I). It is noted that the amount of the polymerization inhibitor is a value in which a polymerization inhibitor contained in advance in the component (2) or the component (5) is taken into account. In other words, generally, the component (2) or the component (5) of the invention (I) includes a polymerization inhibitor in advance, and the amount obtained by combining the amount of the polymerization inhibitor and the total amount of a newly added polymerization inhibitors is 0.01 to 5 mass % with respect to the total amount of the polymerizable composition of the invention (I).

The antioxidant is not particularly restricted, and examples thereof include pentaerythritol tetrakis[3-(3,5-di-tert-butyl-4-hydroxyphenyl)propionate], octadecyl-3-(3,5-di-tert-butyl-4-hydroxyphenyl)propionate, thiodiethylene bis[3-(3,5-di-tert-butyl-4-hydroxyphenyl)propionate], C7-9 alkyl ester of 3,5-di-tert-butyl-4-hydroxybenzene propanoic acid, 4,6-bis(octyl thiomethyl)-o-cresol, 3,9-bis[2-[3-(3-tert-butyl-4-hydroxy-5-methyl phenyl)propionyloxy]-1,1-dimethylethyl]-2,4,8,10-tetraoxaspiro[5,5]-undecane, 2,2′-methylene bis(6-tert-butyl-4-methyl phenol), 4,4′-butylidene bis(6-tert-butyl-3-methyl phenol), 4,4′-thiobis(2-tert-butyl-5-methyl phenol), N,N′,N″-tris(3,5-di-tert-butyl-4-hydroxybenzil)isocyanurate, 1,1,3-tris(2-methyl-4-hydroxy-5-tert-butylphenyl)butane, and 1,1-bis(2-methyl-4-hydroxy-5-tert-butylphenyl)butane. Among these, preferred are pentaerythritol tetrakis[3-(3,5-di-tert-butyl-4-hydroxyphenyl)propionate] and octadecyl-3-(3,5-di-tert-butyl-4-hydroxyphenyl)propionate; and most preferred is pentaerythritol tetrakis[3-(3,5-di-tert-butyl-4-hydroxyphenyl)propionate].

Usually, the antioxidant can be adjusted such that the amount thereof added is 0.01 to 5 mass % with respect to the total amount of the polymerizable composition of the invention (I). It is noted that the amount of the polymerization inhibitor is a value in which an antioxidant contained in advance in other components such as the component (4) is taken into account. In other words, generally, the component (4) or the like of the invention (I) may include an antioxidant in advance, and the amount obtained by combining the amount of the antioxidant and the total amount of a newly added antioxidants is 0.01 to 5 mass % with respect to the total amount of the polymerizable composition of the invention (I).

Examples of the modifying agent include a leveling agent for improving the leveling properties. Examples of the leveling agent which can be used include polyether-modified dimethylpolysiloxane copolymer, polyester-modified dimethylpolysiloxane copolymer, polyether-modified methyl alkyl polysiloxane copolymer, aralkyl-modified methyl alkyl polysiloxane copolymer, and acrylic ester copolymer. These can be used singly or in combination of two or more thereof. A leveling agent can be added in an amount of from 0.01 to 5 mass % with respect to the total amount of the polymerizable composition of the invention (I) with respect to the total amount of the polymerizable composition of the invention (I). When the amount is smaller than 0.01 mass %, it is possible that the effect of adding the leveling agent will not be obtained. When the amount is larger than 5 mass %, depending on the type of the leveling agent to be used, surface tack may be observed, or the electrical insulation properties may deteriorate.

The antifoaming agent is not particularly limited, as long as, literally, it is one which has a function of removing or suppressing air bubbles which are generated or remain when the polymerizable composition of the invention (I) is applied.

Examples of the antifoaming agent used for the polymerizable composition of the invention (I) include a known antifoaming agent such as a silicone-based oil, a fluorine-containing compound, a polycarboxylic acid-based compound, a polybutadiene-based compound, or an acetylene diol-based compound. Specific examples thereof include a silicone-based antifoaming agent such as BYK-077 (manufactured by BYK Japan KK), SN-DEFOAMER 470 (manufactured by SAN NOPCO LIMITED), TSA750S (manufactured by Momentive Performance Materials Inc.), silicone oil SH-203 (manufactured by Dow Corning Toray Co., Ltd.); an acrylic polymer antifoaming agent such as Dappo SN-348 (manufactured by SAN NOPCO LIMITED), Dappo SN-354 (manufactured by SAN NOPCO LIMITED), Dappo SN-368 (manufactured by SAN NOPCO LIMITED), DISPARLON 230HF (manufactured by Kusumoto Chemicals, Ltd.); an acetylene diol antifoaming agent such as Surfynol DF-110D (manufactured by Nissin Chemical Industry Co., Ltd.), Surfynol DF-37 (manufactured by Nissin Chemical Industry Co., Ltd.); and a fluorine-containing silicone-based antifoaming agent such as FA-630. These may be used singly or in combination of two or more thereof. Usually, an antifoaming agent can be added in an amount of 0.001 to 5 mass % with respect to the total amount of the polymerizable composition of the invention (I). When the amount is smaller than 0.01 mass %, it is possible that the effect of adding the antifoaming agent will not be obtained. When the amount is larger than 5 mass %, depending on the types of the antifoaming agent to be used, surface tack may be observed, or the electrical insulation properties may deteriorate.

Examples of a colorant include known inorganic pigments, organic pigments, and organic dyes. These are blended in accordance with a desired color tone, and may be used singly or in combination of two or more thereof.

Next, the polymer of the invention (II) will be described.

The invention (II) is a polymer obtained by polymerizing the polymerizable composition of the invention (I).

In a specific manufacturing method of the polymer of the invention (II), firstly, the polymerizable composition is applied on a substrate by using a dispenser or the like. Next, the substrate and another substrate are stacked such that they sandwich a polymerizable composition via a spacer, and then the polymerizable composition of the invention (I) is irradiated with light to which a photopolymerization initiator is photosensitive via either of the substrates using a high pressure mercury lamp, a metal halide lamp, an LED or the like as a light source to polymerize, thereby obtaining a polymer of the invention (II).

The refractive index of the polymer of the invention (II) at 25° C. is preferably from 1.45 to 1.55, and further preferably from 1.48 to 1.52. When the refractive index at 25° C. is smaller than 1.45 or larger than 1.55, it is smaller than the refractive index of an optical glass or an acrylic resin such as polymethyl methacrylate, and therefore the refractive index difference at the interface between a display unit and a protection unit becomes large to some extent, thereby increasing scattering and attenuation of an image light from a display unit to some extent, which is not preferred.

Next, a manufacturing method of an image-display device of the invention (III) and an image-display device of the invention (IV) will be described.

The invention (III) is a manufacturing method of an image-display device comprising a base unit including an image-display unit, a translucent protection unit, and a polymer layer interposed between the base unit and the protection unit, the method comprising: a process in which the polymerizable composition of the invention (I) is interposed between the base unit and the protection unit; and a process in which the polymerizable composition is irradiated with light to which a photopolymerization initiator is photosensitive, to form a polymer layer.

A preferred embodiment of the image-display device will be described more specifically with reference to the Drawings. In the Drawings, the same numeral represents the same or a similar component.

FIG. 1 and FIG. 2 are cross sections illustrating a main unit of one embodiment of an image-display device pertaining to the invention. As illustrated in FIG. 1 and FIG. 2, the display device 1 of the present embodiment is connected to a driving circuit which is not illustrated, and comprises an image-display unit 2 which displays a predetermined image and a translucent protection unit 3 disposed opposed to the image-display unit 2 adjacently by a predetermined distance.

An “image-display device” as described herein is not particularly restricted, as long as it is a device which displays an image, and a variety of devices are applicable. Examples thereof include a liquid crystal display device such as a cellular phone or a portable game device. The image-display unit 2 of the present embodiment is a liquid crystal display panel of such a liquid crystal display device.

In addition, when the image-display unit 2 is a liquid crystal display panel, polarizing plates 6, 7 are provided on the surface thereof, as illustrated in FIG. 2.

In a manufacturing method of the image-display device 1 of the present embodiment, for example, firstly, a spacer 4 and a jetty portion which is not illustrated are provided on a periphery portion of the image-display unit 2, and the polymerizable composition of the invention (I) is dropped onto a region inside them in a predetermined amount.

Next, a protection unit 3 is arranged on the spacer 4 of the image-display unit 2, and a space between the display unit 2 and the protection unit 3 is filled with the polymerizable composition of the invention (I), without a clearance.

Thereafter, the polymerizable composition of the invention (I) is irradiated with light to which the component (3) which is an essential component of the polymerizable composition of the invention (I) is photosensitive via the protection unit 3 to polymerize the polymerizable composition of the invention (I), thereby obtaining an objective image-display device 1.

By using the image-display device 1, since the refractive indices of the polymer layer 5 and the protection unit 3 are similar, the brightness or contrast can be increased, thereby improving the visibility.

Further, since an influence of stress induced by the volume shrinkage during polymerization of the polymerizable composition onto the image-display unit 2 and protection unit 3 can be minimized, scarcely any deformation on the image-display unit 2 and the protection unit 3 occurs. As a result, since a deformation is not generated on the image-display unit 2, an image with high brightness and high contrast can be displayed without a display failure.

The invention (IV) is an image-display device manufactured by the manufacturing method of an image-display device of the invention (III).

When a main body of a liquid crystal display panel of the image-display device of the invention (IV) is formed of optical glass, the refractive index (n_{D}) thereof is generally from 1.49 to 1.52. In addition, there exists a tempered glass whose refractive index (n_{D}) is about 1.55.

The protection unit 3 is formed by a translucent member in the shape of a plate, sheet or film having approximately the same size as the display unit 2. For the translucent member, optical glass or plastics (for example, an acrylic resin such as polymethyl methacrylate) can be suitably employed. On the front surface or the back surface of the protection unit 3, an optical layer such as an anti-reflection film, a light-shielding film, or a viewing angle control film may be formed.

When the protection unit 3 is formed of an acrylic resin, generally, the refractive index (n_{D}) thereof is from 1.49 to 1.51.

The protection unit 3 is provided on the display unit 2 via a spacer 4 provided on the periphery portion of the display unit 2. The thickness of the spacer 4 is about from 0.05 to 1.5 mm, and the distance between the surfaces of the image-display unit 2 and the protection unit 3 is thus maintained at about 1 mm.

In order to improve the brightness and contrast, a light-shielding portion having a frame shape which is not illustrated is provided on the periphery portion of the protection unit 3.

A polymer layer 5 is interposed between the image-display unit 2 and the protection unit 3. Since the polymer of the invention (II) is interposed in the polymer layer 5, the transmittance in the visible light region is 90% or higher. Here, the thickness of the polymer layer 5 is preferably from 50 to 350 μm.

In addition, since the polymer of the invention (II) is interposed in the polymer layer 5, the refractive index (n_{D}) at 25° C. is from 1.45 to 1.55, preferably 1.48 to 1.52, and therefore the refractive index is approximately the same as the refractive index of the image-display unit 2 or the protection unit 3, which is preferred. The brightness or contrast of an image light from the image-display unit 2 is thus improved, thereby improving the visibility.

Since the polymer of the invention (II) is interposed in the polymer layer 5, the tensile elasticity at 23° C. is preferably 1×10⁷ Pa or lower, more preferably from 1×10³ to 1×10⁶ Pa. As a result, generation of a deformation due to the influence of stress caused by volume shrinkage during polymerization of the polymerizable composition can be prevented.

In addition, since the polymer of the invention (II) is interposed in the polymer layer 5, the volume shrinkage rate during polymerization of the polymerizable composition is preferably 4.0% or lower, more preferably 3.0% or lower. As a result, the internal stress accumulated in a polymer layer during polymerization of the polymerizable composition can be reduced, thereby preventing generation of a deformation at the interface between the polymer layer 5 and the liquid crystal display panel 2 or the protection unit 3. Consequently, when a polymerizable composition is interposed between the liquid crystal display panel 2 and the protection unit 3, and the polymerizable composition is polymerized, scattering of light generated at the interface between the polymer layer 5 and the liquid crystal display panel 2 or the protection unit 3 can be reduced, and the brightness of an image displayed can be increased, and at the same time, the visibility can be improved.

Here, for an optical glass plate to be used, a glass plate which clamps a liquid crystal of a liquid crystal cell or one which is used as a protection plate of a liquid crystal cell is preferably used. As an acrylic resin plate to be used, the one which is used as a protection plate of a liquid crystal cell can be preferably used. The average surface roughness of the optical glass plate or the acrylic resin plate is usually 1.0 nm or smaller.

Since a space between the image-display unit 2 and the protection unit 3 is filled with the polymer layer 5 of the invention (II), the image-display device has a high impact resistance.

In addition, the image-display device can be formed in a thinner shape than a conventional example in which a space is provided between an image-display unit and a protection unit.

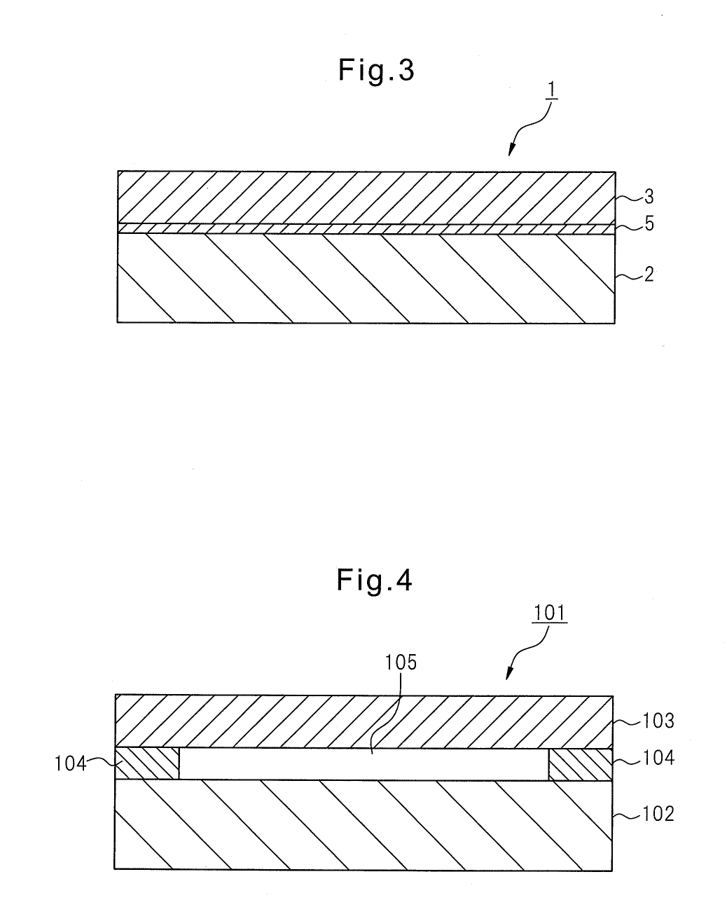

The image-display device of the invention (IV) can take a variety of modes. For example, as illustrated in FIG. 3, the image-display device 1 may be manufactured by omitting a spacer 9. In this case, the photopolymerizable composition of the invention (I) is applied on the base unit 2, the protection unit 3 is placed thereon, and then photopolymerization is performed in a similar manner to the above.

Further, the present invention can be applied not only to the above-mentioned liquid crystal display device, but also to a variety of panel displays such as an organic EL and a plasma display device.

### EXAMPLES

In the following, the present invention will be described more concretely by way of Examples, but should not be limited thereto.

### <Measurement of Viscosity>

The viscosity was measured according to the following method.

Using 1 mL of sample, and using a Cone/Plate type viscometer (manufactured by Brookfield, model: DV-II+Pro, spindle model: CPE-42), a value of the viscosity when it became constant at a temperature of 25.0° C., at a number of revolutions of 10 rpm was measured.

### <Measurement of Hydroxyl Group Value>

The measurement was performed in accordance with JIS K 0070.

### <Number-Average Molecular Weight>

The number-average molecular weight is a value in terms of polystyrene measured by GPC under the conditions below.

device name: manufactured by JASCO Corporation, HPLC unit, HSS-2000

column: Shodex column LF-804

mobile phase: tetrahydrofurane

flow rate: 1.0 mL/min

detector: manufactured by JASCO Corporation, RI-2031Plus

temperature: 40.0° C.

amount of sample: Sample Loop 100 μL

sample concentration: prepared at about 0.5 wt %

### Synthesis Example 1

Into a 500 mL reaction vessel provided with a stirrer and a distillator, 322.2 g of Pripol® 2033 (manufactured by Croda Japan KK, hydrogenated dimerdiol, hydroxyl group value 202 mg KOH/g), 87.5 g of sebacic acid dimethyl (manufactured by Tokyo Chemical Industry Co., Ltd.), and 0.18 g of dioctyltin oxide (trade name: DOTO, manufactured by HOKKO CHEMICAL INDUSTRY CO., LTD.) were charged, and transesterification was performed starting at about 170° C. under a normal pressure and reducing the pressure while discharging methanol. The total amount of distillated methanol was 24.4 g. A (poly)ester polyol whose hydroxyl group value was 58.1 mg KOH/g (hereinafter, referred to as “(poly)ester polyol A”) was obtained.

### Synthesis Example 2

Into a 100 mL reaction vessel provided with a stirrer, a thermometer, a dropping funnel and a condensor, 21.89 g of a mixture of 2,2,4-trimethyl hexamethylene diisocyanate and 2,4,4-trimethyl hexamethylene diisocyanate (trade name: VESTANAT® TMDI, manufactured by Evonik Degussa Corporation), 12 mg of dioctyltin dilaurate and 24 mg of p-methoxyphenol were input, and 15.16 g of 4-hydroxybutyl acrylate was input by dropping using a dropping funnel. During dropping, the temperature in the reaction vessel was maintained at 70° C. or lower. After the completion of dropping, stirring was continued for two hours while maintaining the temperature in the reactor at from 65 to 70° C. to obtain a reaction product (hereinafter referred to as “reaction product α”).

Into a 300 mL reaction vessel provided with a stirrer, a thermometer and a condensor, the above-mentioned 178.9 g of (poly)ester polyol A, 1.1 g of Pripol® 2033 (manufactured by Croda Japan KK, hydrogenated dimerdiol, hydroxyl group value 202 mg KOH/g) and 12 mg of dioctyltin dilaurate were input, and stirring was started. Thereafter, 33.7 g of a reaction product α whose temperature was maintained at 60° C. was divided into several amounts and input into the reaction vessel. During this operation, the temperature in the reactor was kept at not higher than 70° C. Thereafter, the temperature in the reactor was maintained at from 65 to 70° C., and stirring was continued. When it was confirmed by IR that there was no absorption regarding C═O stretching vibration of an isocyanato group, the reaction was completed. As a result of analysis with liquid chromatography, it was confirmed that there was 2 mass % of a reaction product of 4-hydroxybutyl acrylate:VESTANAT® TMDI=2:1 (mole ratio) (i.e., a mixture of the following Formula (6) and (7)) in the product. The reaction product of 4-hydroxybutyl acrylate:VESTANAT® TMDI=2:1 (mole ratio) was designated urethane acrylate monomer α. One which was obtained by removing the urethane acrylate monomer α from the reaction product was designated urethane acrylate 1.

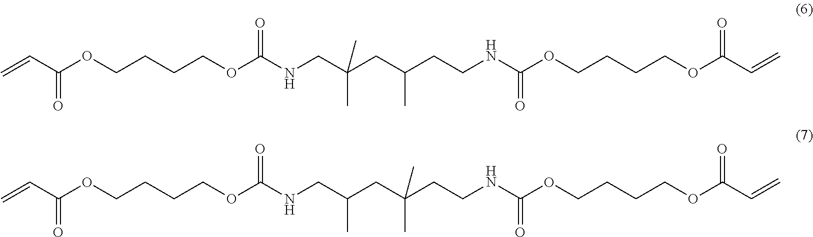

### Synthesis Example 3

Into a 300 mL reaction vessel provided with a stirrer, a thermometer, a dropping funnel and a condensor, the above-mentioned 178.9 g of (poly)ester polyol A, 1.1 g of Pripol® 2033 (manufactured by Croda Japan KK, hydrogenated dimerdiol, hydroxyl group value 202 mg KOH/g) and 20 mg of dioctyltin dilaurate were input, and stirring was started. Thereafter, 13.4 g of 2-isocyanatoethyl acrylate (trade name: Karenz® AOI, manufactured by Showa Denko K.K.) was input by dropping. During this operation, the temperature in the reactor was kept at not higher than 70° C. Thereafter, the temperature in the reactor was maintained at from 65 to 70° C., and stirring was continued. When it was confirmed by IR that there was no absorption regarding C═O stretching vibration of an isocyanato group, the reaction was completed. The manufactured urethane acrylate was designated urethane acrylate 2.

### Synthesis Example 4

A urethane mathacrylate was manufactured by performing a similar operation to that in Synthesis Example 3, except that 14.7 g of 2-isocyanatoethyl methacrylate (trade name: Karenz® MOI, manufactured by Showa Denko K.K.) was used in place of 13.4 g of 2-isocyanatoethyl acrylate (trade name: Karenz® AOI, manufactured by Showa Denko K.K.). The manufactured urethane mathacrylate was designated urethane mathacrylate 1.

### Synthesis Example 5

Into a 500 mL reaction vessel provided with a stirrer and a distillator, 341.2 g of Pripol® 2033 (manufactured by Croda Japan KK, hydrogenated dimerdiol, hydroxyl group value 202 mg KOH/g), 108.6 g of sebacic acid dimethyl (manufactured by Tokyo Chemical Industry Co., Ltd.), and 0.18 g of di-n-octyltin oxide (trade name: DOTO, manufactured by HOKKO CHEMICAL INDUSTRY CO., LTD.) were charged, and transesterification was performed starting at about 170° C. under normal pressure and reducing the pressure while distilling methanol. The total amount of distillated methanol was 30.2 g. A (poly)ester polyol whose hydroxyl group value was 38.2 mg KOH/g (hereinafter referred to as “(poly)ester polyol B”) was obtained.

### Synthesis Example 6

Into a 500 mL reaction vessel provided with a stirrer and a condensor, 300 g of (poly)ester polyol B and 27.7 g of 1,9-nonanediol diacrylate (trade name: NK ester A-NOD-N, manufactured by Shin Nakamura Chemical Co., Ltd.), 0.5 g of titanium tetrabutoxide and 0.05 g of p-methoxyphenol were input, and stirring was started. Using an oil bath, the temperature was raised to 130° C., and stirring was continued for seven hours. When it was confirmed by gas chromatography that 95% or more of 1,9-nonanediol diacrylate had disappeared, the reaction was completed. A polymer whose number-average molecular weight by GPC was 1600 was obtained (hereinafter referred to as “(poly)ester acrylate 1”).

### Synthesis Example 7

Into a 500 mL reaction vessel provided with a stirrer and a distillator capable of recirculation, 366.6 g of Pripol® 2033 (manufactured by Croda Japan KK, hydrogenated dimerdiol, hydroxyl group value 202 mg KOH/g), 54.3 g of diethyl carbonate (manufactured by Tokyo Chemical Industry Co., Ltd.), 0.2 g of titanium tetrabutoxide, 0.12 g of dioctyltin oxide (trade name: DOTO, manufactured by HOKKO CHEMICAL INDUSTRY CO., LTD.) were charged, and the temperature was raised to 130° C. by using an oil bath, and then the temperature was raised to 180° C. in accordance with the progress of the reaction. Transesterification was performed starting at normal pressure and reducing the pressure while distilling ethanol. In addition, the amount of diethyl carbonate (manufactured by Tokyo Chemical Industry Co., Ltd.) which was distilled together with ethanol during distilling ethanol was confirmed by gas chromatography, and the distillated amount of diethyl carbonate was added. The total amount of distillated ethanol was 29.5 g. A (poly) carbonate polyol whose hydroxyl group value was 57.3 mg KOH/g (hereinafter referred to as “(poly)carbonate polyol A”) was obtained.

### Synthesis Example 8

Into a 300 mL reaction vessel provided with a stirrer, a thermometer, a dropping funnel and a condensor, the above-mentioned 177.8 g of (poly)carbonate polyol A, 2.2 g of Pripol® 2033 (manufactured by Croda Japan KK, hydrogenated dimerdiol, hydroxyl group value 202 mg KOH/g) and 20 mg of dioctyltin dilaurate were input, and stirring was started. Thereafter, 14.7 g of 2-isocyanatoethyl methacrylate (trade name: Karenz® MOI, manufactured by Showa Denko K.K.) was input by dropping. During this operation, the temperature in the reactor was kept at not higher than 70° C. Thereafter, the temperature in the reactor was maintained at from 65 to 70° C., and stirring was continued. When it was confirmed by IR that there was no absorption regarding C═O stretching vibration of an isocyanato group, the reaction was completed. The manufactured urethane methacrylate was designated urethane methacrylate 2.

### Synthesis Example 9

Into a 500 mL reaction vessel provided with a stirrer and a distillator, 1100.0 g of Pripol® 2033 (manufactured by Croda Japan KK, hydrogenated dimerdiol, hydroxyl group value 204 mg KOH/g), 771.2 g of Pripol® 1009 (manufactured by Croda Japan KK, hydrogenated dimer acid, acid value 194 mg KOH/g), 1.6 g of mono-n-octyltin oxide (trade name: MOTO, manufactured by HOKKO CHEMICAL INDUSTRY CO., LTD.) were charged, and dehydration condensation reaction was performed starting at about 200° C. under normal pressure and reducing the pressure while distilling water. When the rate of water distillation became low, the temperature of the reactor was further raised to about 240° C., and distilling of water was continued. As a result, the total amount of distillated was 144.0 g. A (poly)ester polyol whose hydroxyl group value was 41.0 mg KOH/g (hereinafter referred to as “(poly)ester polyol C”) was obtained.

### Synthesis Example 10

Into a 500 mL reaction vessel provided with a stirrer and a condensor, 300 g of (poly)ester polyol C and 14.48 g of 1,4-butanediol diacrylate (trade name: V#195, manufactured by Osaka Organic Chemical Industry Ltd.), 0.5 g of titanium tetrabutoxide (trade name: DOTO, manufactured by HOKKO CHEMICAL INDUSTRY CO., LTD.) and 0.05 g of p-methoxyphenol were input, and stirring was started. Using an oil bath, the temperature was raised to 130° C., and stirring was continued for seven hours. When it was confirmed by gas chromatography that 97% or more of 1,4-butanediol diacrylate was disappeared, the reaction was completed. A polymer whose number-average molecular weight by GPC was 1860 was obtained (hereinafter referred to as “(poly)ester acrylate 2”).

### Synthesis Example 1

Into a 500 mL reaction vessel provided with a stirrer and a condensor, 300 g of (poly)ester polyol C and 21.72 g of 1,4-butanediol diacrylate (trade name: V#195, manufactured by Osaka Organic Chemical Industry Ltd.), 0.5 g of titanium tetrabutoxide (trade name: DOTO, manufactured by HOKKO CHEMICAL INDUSTRY CO., LTD.) and 0.05 g of p-methoxyphenol were input, and stirring was started. Using an oil bath, the temperature was raised to 130° C., and stirring was continued for seven hours. When it was confirmed by gas chromatography that 95% or more of 1,4-butanediol diacrylate was disappeared, the reaction was completed. A polymer whose number-average molecular weight by GPC was 1480 was obtained (hereinafter referred to as “(poly)ester acrylate 3”).

### Blending Example 1

30.77 g of the urethane acrylate 1, 0.63 g of the urethane acrylate monomer α, 18.3 g pf lauryl acrylate (trade name: BLEMMER LA, manufactured by NOF CORPORATION), 3 g of 2-hydroxypropyl methacrylate (trade name: HPMA, manufactured by MITSUBISHI RAYON CO., LTD.), 29 g of hydrogenated terpene resins (trade name: CLEARON® P85, manufactured by YASUHARA CHEMICAL Co., Ltd.), 0.3 g of pentaerythritol tetrakis[3-(3,5-di-tert-butyl-4-hydroxyphenyl)propionate](trade name: IRGANOX® 1010, manufactured by BASF) and 1 g of 2,4,6-trimethylbenzoyl diphenylphosphine oxide (trade name: SpeedCure TPO, manufactured by Lambson) were mixed by using Planetary and Centrifugal Mixer (manufactured by THINKY CORPORATION, trade name: Awatori-rentaro ARE-310). This blend was designated polymerizable composition A1. The viscosity of the polymerizable composition A1 at 25° C. was 3900 mPa·s.

### Blending Example 2 to 9 and Comparative Blending Example 1 to 2

In a similar manner to Blending Example 1, blending was performed in accordance with the blend compositions listed in Table 1. The blends prepared in Blending Examples 2 to 9 were designated polymerizable compositions A2 to A9, respectively. The blends prepared in Comparative Blending Example 1 and Comparative Synthesis Example 2 were designated polymerizable composition B1 and polymerizable composition B2, respectively.

In addition, the unit of the value of each component in Blending Examples and Comparative Blending Examples is “parts by mass”.

TABLE 1

| | | | | | | | | | | Comparative | Comparative |
|---|---|---|---|---|---|---|---|---|---|---|---|
| | Blending | Blending | Blending | Blending | Blending | Blending | Blending | Blending | Blending | Blending | Blending |
| | Example 1 | Example 2 | Example 3 | Example 4 | Example 5 | Example 6 | Example 7 | Example 8 | Example 9 | Example 1 | Example 2 |
| Blend Composition Name | Polymerizable | Polymerizable | Polymerizable | Polymerizable | Polymerizable | Polymerizable | Polymerizable | Polymerizable | Polymerizable | Polymerizable | Polymerizable |
| | Composition | Composition | Composition | Composition | Composition | Composition | Composition | Composition | Composition | Composition | Composition |
| | A1 | A2 | A3 | A4 | A5 | A6 | A7 | A8 | A9 | B1 | B2 |
| Urethane acrylate 1 | 30.77 | | | | | 47.04 | | 48.04 | | | |
| Urethane acrylate 2 | | 38.0 | | | | | | | | | |
| Urethane mathacrylate 1 | | | 34.0 | | | | | | | | |
| (Poly)ester acrylate 1 | | | | 38.5 | | | | | | | |
| Urethane mathacrylate 2 | | | | | 31.5 | | | | | | |
| Urethane mathacrylate 3 | | | | | | | | | | | |
| (Poly)ester acrylate 2 | | | | | | | | | 80.0 | | |
| (Poly)ester acrylate 3 | | | | | | | 70.0 | | | | |
| Urethane acrylate SHIKOH | | | | | | | | | | 50.0 | |
| UV-3000B*¹ | | | | | | | | | | | |
| Kuraprene ® UC-203*² | | | | | | | | | | | 70.0 |
| Isobornyl acrylate*³ | | | | | | | | | 10.0 | 30.0 | |
| Dicylopentenyl oxyethyl | | | | | | | | | | | 30.0 |
| methacrylate*⁴ | | | | | | | | | | | |
| Urethane acrylate | 0.63 | | | | | 0.96 | | 0.96 | | | |
| monomer α | | | | | | | | | | | |
| Lauryl acrylate*⁵ | 18.3 | 15.4 | 20.0 | 15.0 | 18.5 | 20.0 | 20.0 | 20.0 | 10.0 | | |
| Isodecyl acrylate*⁶ | | 5 | | 5.0 | | | | | | | |
| 2-hydroxypropyl | 3.0 | 3.0 | | 3.0 | 3.0 | 3.0 | | 3.0 | | | |
| methacrylate*⁷ | | | | | | | | | | | |
| 4-hydroxybutyl acrylate*⁸ | | | 3.0 | | | | | | | | |
| 2-hydroxybutyl | | | | | | | | | | | 10.0 |
| methacrylate*⁹ | | | | | | | | | | | |
| Hydrogenated terpene | 29.0 | | | | 29.0 | | | | | | 30.0 |
| resins CLEARON ® P85*¹⁰ | | | | | | | | | | | |
| Hydrogenated terpene | | 14.3 | 15.0 | 14.5 | | | | | | | |
| resins CLEARON ® P105*¹¹ | | | | | | | | | | | |
| Hydrogenated terpene | | 14.0 | 13.0 | 14.0 | | | | | | | |
| resins CLEARON ® M105*¹² | | | | | | | | | | | |
| Hydrogenated terpene | | | | | | 28.0 | 10.0 | 28.0 | | | |
| resins CLEARON ® K100*¹³ | | | | | | | | | | | |
| hydrogenated polybutadiene | 18.0 | 10.0 | 14.0 | | 18.0 | | | | | | |
| polyol | | | | | | | | | | | |
| GI-2000*¹⁴ | | | | | | | | | | | |
| hydrogenated polyisoprene | | | | 10.0 | | | | | | | |
| polyol Epol*¹⁵ | | | | | | | | | | | |
| POLYVEST 110*¹⁶ | | | | | | | | | | | 140.0 |
| IRGANOX 1010*¹⁷ | 0.3 | 0.3 | 1.0 | | | 1.0 | | | | | 0.3 |
| photopolymerization | 1.0 | 1.0 | 1.0 | 1.0 | 1.0 | 1.0 | 1.0 | 1.0 | 1.0 | 1.0 | 0.5 |
| initiator SpeedCure TPO*¹⁸ | | | | | | | | | | | |
| photopolymerization | | | | | | | | | | 3.0 | 4.0 |
| initiator IRGACURE 184*¹⁹ | | | | | | | | | | | |
| viscosity of polymerizable | 3890 mPa · s | 3000 mPa · s | 3340 mPa · s | 1900 mPa · s | 3450 mPa · s | 3460 mPa · s | 3869 mPa · s | 3900 mPa · s | 2500 mPa · s | 3000 mPa · s | 3500 mPa · s |
| composition (25° C.) | | | | | | | | | | | |

*¹Urethane acrylate “SHIKOH” UV-3000B (Polyester-type urethane acrylate, manufactured by The Nippon Synthetic Chemical Industry Co., Ltd.)
*²“Kuraprene” UC-203 (Esterified product of maleic anhydride adduct of polyisoprene polymer and 2-hydroxyethyl methacrylate, manufactured by Kuraray Co., Ltd.)
*³Isobornyl acrylate (Trade name: IBXA, manufactured by Osaka Organic Chemical Industry Ltd.)
*⁴Dicyclopentenyloxyethyl methacrylate (Trade name: FA-512M, manufactured by Hitachi Chemical Co., Ltd.)
*⁵Lauryl acrylate (Trade name: BLEMMER LA, manufactured by NOF Corporation)
*⁶Isodecyl acrylate (Trade name: SR395, manufactured by Sartomer)
*⁷2-Hydroxypropyl methacrylate (Trade name: HPMA, manufactured by Mitsubishi Rayon Co., Ltd.)
*⁸4-Hydroxybutyl acrylate (Trade name: 4HBA, manufactured by Osaka Organic Chemical Industry Ltd.)
*⁹2-Hydroxybutyl methacrylate (Trade name: LIGHT ESTER HOB(N), manufactured by Kyoeisha Chemical Co., Ltd.)
*¹⁰Hydrogenated terpene resin CLEARON ® P85, manufactured by Yasuhara Chemical Co., Ltd.)
*¹¹Hydrogenated terpene resin CLEARON ® P105, manufactured by Yasuhara Chemical Co., Ltd.)
*¹²Hydrogenated terpene resin CLEARON ® M105, manufactured by Yasuhara Chemical Co., Ltd.)
*¹³Hydrogenated terpene resin CLEARON ® K100, manufactured by Yasuhara Chemical Co., Ltd.)
*¹⁴Hydrogenated polybutadiene polyol GI-2000 (manufactured by Nippon Soda Co., Ltd.)
*¹⁵Hydrogenated polyisoprene polyol “Epol” (manufactured by Idemitsu Kosan Co., Ltd.)
*¹⁶POLYVEST 110 (Compound name: liquid polybutadiene, manufactured by Evonik Degussa Corporation)
*¹⁷IRGANOX 1010 (Compound name: pentaerythritol tetrakis[3-(3,5-di-tert-butyl-4-hydroxyphenyl)propionate], manufactured by BASF)
*¹⁸Photopolymerization initiator “SpeedCure” TPO (Compound name: 2,4,6-trimethylbenzoyldiphenylphosphine oxide, manufactured by Lambson)
*¹⁹Photopolymerization initiator “IRGACURE” 184 (Compound name: 1-Hydroxycyclohexyl phenyl ketone, manufactured by BASF)

### <Preparation Method of Specimen and Evaluation of Initial Optical Characteristics>

Each of the polymerizable compositions A1 to A9, polymerizable composition B1 and polymerizable composition B2 was applied on a glass plate (50 mm×50 mm×0.7 mm, type of glass, trade name: EAGLE XG®, manufactured by CORNING) by using a bar coater such that the film thickness was 200 μm, and the composition was sandwiched by a glass plate having the same type and the same shape, and then was irradiated with UV light having an irradiation intensity of 190 mW/cm² (value at 365 nm) and an irradiation amount of 2800 mJ/cm² (value at 365 nm) through a glass plate using a conveyer type UV irradiation system (manufactured by GS Yuasa Lighting Ltd., trade name: GSN2-40) using a metal halide lamp to polymerize, thereby obtaining a polymer film for evaluation test in which the film thickness between the glass plates was about 200 μm. The polymer films for evaluation test in which the film thickness between the glass plates was about 200 μm manufactured by using polymerizable compositions A1 to A9, polymerizable composition B1 and polymerizable composition B2 were designated specimens A1 to A9, specimen B1 and specimen B2, respectively. The overall light transmittance, haze and b* of these specimens were measured in the method below. The results thereof are listed in Table 3.

### <Measurement of Overall Light Transmittance>

By using a reference in which distilled water was placed between two glass plates (50 mm×50 mm×0.7 mm, type of glass, trade name: EAGLE XG®, manufactured by CORNING) arranged at a gap of 200 μm, the overall light transmittance of each of specimens A1 to A9, specimen B1 and specimen B2 was measured in accordance with JIS K 7361-1.

### <Measurement of Haze>

By using a reference in which distilled water was placed between two glass plates (50 mm×50 mm×0.7 mm, type of glass, trade name: EAGLE XG®, manufactured by CORNING) arranged at a gap of 200 μm, the overall light transmittance of each of specimens A1 to A9, specimen B1 and specimen B2 was measured in accordance with JIS K 7361.

<Measurement of b*>

By using a reference in which distilled water was placed between two glass plates (50 mm×50 mm×0.7 mm, type of glass, trade name: EAGLE XG®, manufactured by CORNING) arranged at a gap of 200 μm, the overall light transmittance of each of specimens A1 to A9, specimen B1 and specimen B2 was measured in accordance with JIS Z 8729.

### <Measurement of Refractive Index>

By using two silicone coated polyethylene terephthalate films, polymerizable compositions A1 to A9, polymerizable composition B1 and polymerizable composition B2 were sandwiched therebetween such that the film thickness was 200 μm, and then was irradiated with UV light having an irradiation intensity of 190 mW/cm² (value at 365 nm) and an irradiation amount of 2800 mJ/cm² (value at 365 nm) through a silicone coated polyethylene terephthalate film using a conveyer type UV irradiation system (manufactured by GS Yuasa Lighting Ltd., trade name: GSN2-40) using a metal halide lamp to polymerize, thereby obtaining a polymer film for evaluation test in which the film thickness between the silicone coated polyethylene terephthalate films was about 200 μm. This polymer film was separated from a silicone coated polyethylene terephthalate film, and measurement was performed in accordance with JIS K 7105. The results thereof are listed in Table 2.

In addition, polymer films separated from silicone coated polyethylene terephthalate films obtained by polymerizing polymerizable compositions A1 to A9, polymerizable composition B1 and polymerizable composition B2.

### <Measurement of Volume Shrinkage Rate During Polymerization>

The densities of polymerizable compositions A1 to A9, polymerizable composition B1 and polymerizable composition B2 before polymerization, and polymers thereof (i.e., polymer films A1 to A9, polymer film B1 and polymer film B2) were measured using a specific gravity meter (model: DMA-220H, manufactured by SHINKO DENSHI CO., LTD.) in a temperature condition of 23° C., and the volume shrinkage rate during polymerization was calculated based on the following formula:

volume shrinkage rate (%) during polymerization=(density of polymer−density of polymerizable composition)/(density of polymer)×100.

The results thereof are listed in Table 2.

### <Measurement of Tensile Elasticity>

Polymer films A1 to A9, polymer film B1 and polymer film B2 were fixed on a tensile tester (manufactured by SHIMADZU CORPORATION, EZ Test/CE), and a test was performed at a drawing speed of 500 mm/min at 23° C. to determine the tensile elasticity. The results thereof are listed in Table 2.

<Measurement of Overall Light Transmittance, Haze and b* Value when Stored in a High Temperature Condition>

Each of specimens A1 to A9, specimen B1 and specimen B2 was input in a constant temperature apparatus whose temperature was 70° C., 85° C. or 95° C., and by using a specimen which was left to stand for 500 hours, the overall light transmittance, haze and b* thereof were measured by the above-mentioned methods. The results thereof are listed in Table 3.

<Measurement of Overall Light Transmittance, Haze and b* Value when Stored in a High Temperature and High Humidity Condition>

Each of specimens A1 to A9, specimen B1 and specimen B2 was input in a constant temperature apparatus whose humidity was 60° C. or 90% RH, and by using a specimen which was left to stand for 500 hours, the overall light transmittance, haze and b* thereof were measured by the above-mentioned methods. The results thereof are listed in Table 4.

TABLE 2

| | Name of polymerizable composition used | | | | | |
|---|---|---|---|---|---|---|
| | Polymerizable | Polymerizable | Polymerizable | Polymerizable | Polymerizable | Polymerizable |
| | composition | composition | composition | composition | composition | composition |
| | A1 | A2 | A3 | A4 | A5 | A6 |
| Name of | Polymer | Polymer | Polymer | Polymer | Polymer | Polymer |
| polymer film | film a1 | film a2 | film a3 | film a4 | film a5 | film a6 |
| used | | | | | | |
| Volume | 1.9% | 2.2% | 2.1% | 2.3% | 2.0% | 2.7% |
| shrinkage rate | | | | | | |
| during | | | | | | |
| polymerization | | | | | | |
| (23° c.) | | | | | | |
| Refractive | 1.49 | 1.50 | 1.50 | 1.50 | 1.49 | 1.51 |
| index n_{d} of | | | | | | |
| Polymer film | | | | | | |
| (25° c.) | | | | | | |
| Tensile | 1.2 × 10⁵ Pa | 1.0 × 10⁵ Pa | 1.7 × 10⁵ Pa | 1.0 × 10⁵ Pa | 1.2 × 10⁵ Pa | 1.0 × 10⁶ Pa |
| elasticity | | | | | | |
| (23° c.) | | | | | | |
| | | Name of polymerizable composition used | | | | |
| | | Polymerizable | Polymerizable | Polymerizable | Polymerizable | Polymerizable |
| | | composition | composition | composition | composition | composition |
| | | A7 | A8 | A9 | B1 | B2 |
| | Name of | Polymer | Polymer | Polymer | Polymer | Polymer |
| | polymer film | film a7 | film a8 | film a9 | film b1 | film b2 |
| | used | | | | | |
| | Volume | 2.8% | 2.7% | 3.6% | 4.5% | 1.8% |
| | shrinkage rate | | | | | |
| | during | | | | | |
| | polymerization | | | | | |
| | (23° c.) | | | | | |
| | Refractive | 1.50 | 1.51 | 1.49 | 1.47 | 1.52 |
| | index n_{d} of | | | | | |
| | Polymer film | | | | | |
| | (25° c.) | | | | | |
| | Tensile | 8.0 × 10⁶ Pa | 1.0 × 10⁶ Pa | 1.0 × 10⁶ Pa | 1.0 × 10⁶ Pa | 1.0 × 10⁴ Pa |
| | elasticity | | | | | |
| | (23° c.) | | | | | |

TABLE 3

| | | Temperature condition | | | | | |
|---|---|---|---|---|---|---|---|
| | | 70° C. | 85° C. | 95° C. | | | |
| | | Immediately after | | | | | |
| | | polymerization | | | 70° C. | 85° C. | 95° C. |
| | | (after 0 hour) | | | After 500 hours | | |
| Specimen A1 | B* | 0.22 | 0.21 | 0.21 | 0.23 | 0.27 | 0.50 |
| | Overall light transmittance | 100 | 100 | 100 | 100 | 100 | 100 |
| | Haze | 0.21 | 0.13 | 0.13 | 0.00 | 0.00 | 0.00 |
| Specimen A2 | B* | 0.18 | 0.17 | 0.17 | 0.21 | 0.28 | 0.52 |
| | Overall light transmittance | 100 | 100 | 100 | 100 | 100 | 100 |
| | Haze | 0.14 | 0.12 | 0.11 | 0.10 | 0.00 | 0.00 |
| Specimen A3 | B* | 0.18 | 0.18 | 0.18 | 0.21 | 0.33 | 0.56 |
| | Overall light transmittance | 100 | 100 | 100 | 100 | 100 | 100 |
| | Haze | 0.00 | 0.03 | 0.03 | 0.10 | 0.00 | 0.00 |
| Specimen A4 | B* | 0.18 | 0.17 | 0.17 | 0.21 | 0.27 | 0.51 |
| | Overall light transmittance | 100 | 100 | 100 | 100 | 100 | 100 |
| | Haze | 0.14 | 0.12 | 0.11 | 0.11 | 0.00 | 0.00 |
| Specimen A5 | B* | 0.21 | 0.21 | 0.21 | 0.23 | 0.27 | 0.55 |
| | Overall light transmittance | 100 | 100 | 100 | 100 | 100 | 100 |
| | Haze | 0.13 | 0.13 | 0.13 | 0.00 | 0.00 | 0.00 |
| Specimen A6 | B* | 0.19 | 0.19 | 0.19 | 0.24 | 0.32 | 0.60 |
| | Overall light transmittance | 100 | 100 | 100 | 100 | 100 | 100 |
| | Haze | 0.05 | 0.00 | 0.00 | 0.10 | 0.09 | 0.11 |
| Specimen A7 | B* | 0.21 | 0.21 | 0.21 | 0.23 | 0.27 | 0.60 |
| | Overall light transmittance | 100 | 100 | 100 | 100 | 100 | 100 |
| | Haze | 0.13 | 0.13 | 0.13 | 0.00 | 0.00 | 0.00 |
| Specimen A8 | B* | 0.20 | 0.20 | 0.20 | 0.27 | 0.35 | 0.66 |
| | Overall light transmittance | 100 | 100 | 100 | 100 | 100 | 100 |
| | Haze | 0.05 | 0.00 | 0.00 | 0.10 | 0.09 | 0.11 |
| Specimen A9 | B* | 0.20 | 0.20 | 0.20 | 0.24 | 0.32 | 0.66 |
| | Overall light transmittance | 100 | 100 | 100 | 100 | 100 | 100 |
| | Haze | 0.05 | 0.00 | 0.00 | 0.10 | 0.09 | 0.11 |
| Specimen B1 | B* | 0.22 | 0.22 | 0.22 | 0.23 | 0.27 | 0.60 |
| | Overall light transmittance | 100 | 100 | 100 | 100 | 100 | 100 |
| | Haze | 0.21 | 0.21 | 0.21 | 0.00 | 0.00 | 0.11 |
| Specimen B2 | B* | 0.19 | 0.19 | 0.19 | 0.32 | 0.40 | 0.90 |
| | Overall light transmittance | 100 | 100 | 100 | 100 | 100 | 100 |
| | Haze | 0.07 | 0.07 | 0.07 | 0.10 | 0.09 | 0.09 |

TABLE 4

| | | Temperature &. humidity | |
|---|---|---|---|
| | | conditions 60° C., | |
| | | 90% RH | |
| | | Immediately | |
| | | after | |
| | | polymerization | After |
| | | (after 0 hour) | 500 hours |
| Specimen A1 | B* | 0.22 | 0.29 |
| | Overall light transmittance | 100 | 100 |
| | Haze | 0.21 | 0.15 |
| Specimen A2 | B* | 0.18 | 0.16 |
| | Overall light transmittance | 100 | 100 |
| | Haze | 0.14 | 0.40 |
| Specimen A3 | B* | 0.18 | 0.16 |
| | Overall light transmittance | 100 | 100 |
| | Haze | 0.00 | 0.54 |
| Specimen A4 | B* | 0.18 | 0.16 |
| | Overall light transmittance | 100 | 100 |
| | Haze | 0.14 | 0.39 |
| Specimen A5 | B* | 0.21 | 0.29 |
| | Overall light transmittance | 100 | 100 |
| | Haze | 0.13 | 0.10 |
| Specimen A6 | B* | 0.19 | 0.36 |
| | Overall light transmittance | 100 | 99 |
| | Haze | 0.05 | 0.80 |
| Specimen A7 | B* | 0.21 | 0.29 |
| | Overall light transmittance | 100 | 99 |
| | Haze | 0.13 | 0.40 |
| Specimen A8 | B* | 0.19 | 0.31 |
| | Overall light transmittance | 100 | 100 |
| | Haze | 0.05 | 0.10 |
| Specimen A9 | B* | 0.19 | 0.36 |
| | Overall light transmittance | 100 | 99 |
| | Haze | 0.05 | 0.50 |
| Specimen B1 | B* | 0.22 | 0.02 |
| | Overall light transmittance | 100 | 91 |
| | Haze | 0.21 | 20.0 |
| Specimen B2 | B* | 0.19 | 0.30 |
| | Overall light transmittance | 100 | 100 |
| | Haze | 0.07 | 0.36 |

From the results shown in Table 2, Table 3 and Table 4, it was found that the polymerizable composition of the invention (I) had a low volume shrinkage rate during polymerization, and in the polymer film obtained by polymerizing the polymerizable composition of the invention (I), scarcely any change in the outer appearance, such as coloration or haze occurred when stored for a long time in a high temperature condition or when stored for a long time in a high temperature and high humidity condition, and a favorable optical transparency can be maintained.

### INDUSTRIAL APPLICABILITY

As mentioned above, since the polymerizable composition of the invention (I) has a low volume shrinkage rate during polymerization, and in the polymer film obtained by polymerizing the polymerizable composition of the invention (I), scarcely any change in the outer appearance such as coloration or haze occurs when stored for a long time in a high temperature condition or when stored for a long time in a high temperature and high humidity condition, and a favorable optical transparency can be maintained, a favorable optical adhesive layer can be provided when the polymer film is used as a polymer layer interposed between the image-display unit and the translucent protection unit of the image-display device.

Therefore, the use of the polymer for an image-display device is advantageous.

### REFERENCE SIGNS LIST

1 Display device
2 Display unit
3 Protection unit
4 Spacer
5 Polymer or polymer layer
6, 7 Polarizing plate

1. A polymerizable composition for forming a polymer layer interposed between an image-display unit and a translucent protection unit of an image-display device, the polymerizable composition being characterized by comprising:
(1) a (meth)acryloyl group-containing compound having a structural unit derived from a (poly)ester polyol and/or a structural unit derived from a (poly)carbonate polyol;
(2) a (meth)acryloyl group-containing compound having a hydrocarbon group having nine or more carbon atoms; and
(3) a photopolymerization initiator.

2. The polymerizable composition according to claim 1, further comprising:
(4) at least one selected from the group consisting of hydrogenated petroleum resins, hydrogenated terpene resins, hydrogenated rosin esters, hydrogenated polybutadiene and hydrogenated polyisoprene.

3. The polymerizable composition according to claim 1, further comprising:
(5) a (meth)acryloyl group-containing compound having an alcoholic hydroxyl group.

4. The polymerizable composition according to claim 1, further comprising:
(6) at least one selected from the group consisting of a hydrogenated polybutadiene polyol and a hydrogenated polyisoprene polyol.

5. The polymerizable composition according to claim 1, wherein the (meth)acryloyl group-containing compound (1) is a (meth)acryloyl group-containing compound having a structural unit derived from a (poly)ester polyol having a structural unit derived from a hydrogenated dimerdiol and/or a structural unit derived from a (poly)carbonate polyol having a structural unit derived from a hydrogenated dimerdiol.

6. The polymerizable composition according to claim 1, wherein the (meth)acryloyl group-containing compound (1) is a (meth)acryloyl group-containing compound prepared by a reaction of a (poly)ester polyol having a structural unit derived from a hydrogenated dimerdiol and/or a (poly)carbonate polyol having a structural unit derived from a hydrogenated dimerdiol with a (meth)acrylic acid or an alkyl (meth)acrylate.

7. The polymerizable composition according to claim 1, wherein the (meth)acryloyl group-containing compound (1) is a (poly)ester (meth)acrylate prepared by a reaction of a (poly)ester polyol having a structural unit derived from a hydrogenated dimerdiol with a (meth)acrylic acid or an alkyl (meth)acrylate.

8. The polymerizable composition according to claim 1, wherein the (meth)acryloyl group-containing compound (1) is a urethane (meth)acrylate synthesized by using a (poly)ester polyol having a structural unit derived from a hydrogenated dimerdiol and/or a (poly)carbonate polyol having a structural unit derived from a hydrogenated dimerdiol as a raw material component.

9. A polymer obtained by polymerizing the polymerizable composition according to claim 1.

10. The polymer according to claim 9, having a refractive index at 25° C. of from 1.48 to 1.52.

11. A method for manufacturing an image-display device comprising a base unit including an image-display unit, a translucent protection unit, and a polymer layer interposed between the base unit and the protection unit, comprising the steps of
interposing the polymerizable composition according to claim 1 between the base unit and the protection unit; and
irradiating the polymerizable composition with a light to which a photopolymerization initiator is photosensitive to form a polymer layer.

12. An image-display device manufactured by the method for manufacturing an image-display device according to claim 11.

13. The image-display device according to claim 12, wherein the image-display unit is a liquid crystal display panel.

14. The polymerizable composition according to claim 2, further comprising:
(5) a (meth)acryloyl group-containing compound having an alcoholic hydroxyl group.
